(19) United States
(12) Patent Application Publication
(10) Pub. No.: US 2020/0246761 A1
(43) Pub. Date: Aug. 6, 2020

(54) NANOFILTRATION COMPOSITE MEMBRANES COMPRISING SELF-ASSEMBLED SUPRAMOLECULAR SEPARATION LAYER

(71) Applicant: BASF SE, Ludwigshafe am Rhein (DE)

(72) Inventors: Wendel WOHLLEBEN, Mannheim (DE); Karsten SEIDEL, Mannheim (DE); Kai WERLE, Mannheim (DE); Natalia WIDJOJO, Singapore (SG)

(73) Assignee: BASF SE, Ludwigshafe am Rhein (DE)

(21) Appl. No.: 15/776,220

(22) PCT Filed: Nov. 15, 2016
(86) PCT No.: PCT/EP2016/077714

§ 371 Date: May 15, 2018

(30) Foreign Application Priority Data
Nov. 16, 2015 (EP) 15194732.2

(51) Int. Cl. B01D 71/82; B01D 61/02; B01D 67/00; B01D 69/12; B01D 69/02; B01D 71/68; C02F 1/44

(52) U.S. Cl. CPC B01D 71/82; B01D 61/027; B01D 67/0088; B01D 69/12; C02F 2101/101; B01D 71/68; C02F 1/442; B01D 2323/36; B01D 2325/20; B01D 69/02

(57) ABSTRACT

The present invention is directed to nanofiltration (NF) composite membranes comprising at least one polymeric porous substrate layer (S) and at least one porous selfassembled supramolecular membrane layer (F); a method of preparing such composite membranes; method of separation/filtration/purification of heavy metal cations, inorganic anions, and organic small molecules by applying such composite membranes; as well as filter cartridges and filtration devices comprising said composite membranes.

The present invention is directed to nanofiltration (NF) composite membranes comprising at least one polymeric porous substrate layer (S) and at least one porous self-assembled supramolecular membrane layer (F); a method of preparing such composite membranes; method of separation/filtration/purification of heavy metal cations, inorganic anions, and organic small molecules by applying such composite membranes; as well as filter cartridges and filtration devices comprising said composite membranes.

### BACKGROUND OF THE INVENTION

Nanofiltration (NF) is a pressure-driven technique that is gaining popularity due to its low consumption of energy, high water permeability and retention of multivalent ions as compared to the well-established reverse osmosis process [B. Van Der Bruggen, C. Vandecasteele, T. Van Gestel, W. Doyen, R. Leysen, A review of pressure-driven membrane processes in wastewater treatment and drinking water production, Environmental Progress, 22 (2003) 46-56; X.-L. Li, L.-P. Zhu, Y.-Y. Xu, Z. Yi, B.-K. Zhu, A novel positively charged nanofiltration membrane prepared from N,N-dimethylaminoethyl methacrylate by quaternization cross-linking, Journal of Membrane Science, 374 (2011) 33-42.]. Such membranes have been researched for the application in many areas such as pre-treatment for the desalination process and have shown to be able to remove turbidity, microorganisms and dissolved salts .

A NF membrane usually consists of a thin active layer (or separating layer) supported by a porous sublayer or substrate layer. This active layer plays the determining role in permeation and separation characteristics while the porous sublayer imparts the mechanical strength. There are many approaches to fabricate this active layer, namely:

(1) interfacial polymerization [T. K. Dey, R. C. Bindal, S. Prabhakar, P. K. Tewari, Development, Characterization and Performance Evaluation of Positively-Charged Thin Film-Composite Nanofiltration Membrane Containing Fixed Quaternary Ammonium Moieties, Separation Science and Technology, 46 (2011) 933-943.], (2) layer-by-layer assembly [L. Ouyang, R. Malaisamy, M. L. Bruening, Multilayer polyelectrolyte films as nanofiltration membranes for separating monovalent and divalent cations, Journal of Membrane Science, 310 (2008) 76-84; B. W. Stanton, J. J. Harris, M. D. Miller, M. L. Bruening, Ultrathin, Multilayered Polyelectrolyte Films as Nanofiltration Membranes, Langmuir, 19 (2003) 7038-7042.], (3) chemical crosslinking [R. Huang, G. Chen, B. Yang, C. Gao, Positively charged composite nanofiltration membrane from quaternized chitosan by toluene diisocyanate cross-linking, Separation and Purification Technology, 61 (2008) 424-429.] and (4) UV grafting [S. Béquet, J.-C. Remigy, J.-C. Rouch, J.-M. Espenan, M. Clifton, P. Aptel, From ultrafiltration to nanofiltration hollow fiber membranes: a continuous UV-photografting process, Desalination, 144 (2002) 9-14.].

Among these approaches, UV grafting has been applied for years due to its advantages such as ease of operation and low cost [M. Ulbricht, H.-H. Schwarz, Novel high performance photo-graft composite membranes for separation of organic liquids by pervaporation, Journal of Membrane Science, 136 (1997) 25-33; J. Pieracci, D. W. Wood, J. V. Crivello, G. Belfort, UV-Assisted Graft Polymerization of N-vinyl-2-pyrrolidinone onto Poly(ether sulfone) Ultrafiltration Membranes: Comparison of Dip versus Immersion Modification Techniques, Chemistry of Materials, 12 (2000) 2123-2133.]. In addition, the fabrication via UV grafting produces an integral selective layer due to a strong chemical bond to the substrate which provides sufficient mechanical stability under relatively high operating pressure.

It has been known that polyethersulfone (PESU) can generate free radicals upon exposure to UV light due its photosensitive nature [H. Yamagishi, J. V. Crivello, G. Belfort, Development of a novel photochemical technique for modifying poly (arylsulfone) ultrafiltration membranes, Journal of Membrane Science, 105 (1995) 237-247.]. Thus, vinyl monomers in contact with free radicals can form a covalent bond with PESU.

The separation behaviour of NF membranes comprises size exclusion as well as electrostatic repulsion [M. Mulder, Basic Principles of Membrane Technology, 2nd Ed., Kluwer Academic Publishers, Netherlands, 19964].

WO 2015/000801 describes multiple channel membranes comprising multiple longitudinal channels formed within a polymer based carrier and further comprising a polymeric separation layer formed on the inner surface of each of said longitudinal channels.

WO2012/025928 describes recyclable membranes suitable for the separation of nanomaterials. Said membranes are made of self-assembled perylene imide derivatives. Said prior art documents exemplifies the applicability of said membranes for the separation of gold particles and protein molecules such as bovine serum albumin (molecular weight 67 kDa). For this purpose the perylene material is deposited on conventional cellulose acetate support membranes having a pore size around 450 nm. The applicability of such perylene imide materials for the separation of very small molecules or even ions, like metal cations or inorganic small anions, has not been investigated so far.

There is a need of further improved membrane materials which are mechanically stable, easy to manufacture and applicable in the separation of small inorganic ions, metal cations, and small inorganic ions, like nitrate, and which optionally further improved by a reduced tendency of membrane fouling.

### SUMMARY OF THE INVENTION

The above problem is, in particular, solved by providing a new type of composite membrane material as defined in the claims.

### BRIEF DESCRIPTION OF DRAWING

FIG. 1 shows the UV-Vis spectrum of the liquid medium before (black, dotted line) and after passing a NADIR UP150 type PES supporting membrane (black line). Said medium contained in an aqueous phase containing 3% (v/v) THF the supramolecular membrane layer forming compound PP2b (1 mg/ml).The spectra clearly show that PP2b was quantitatively deposited.

FIG. 2 illustrates the influence of an increasing THF concentration on the fibrille size before PP2b deposition. 1% THF (dash-dotted line); 3% THF (dotted line); 6% THF (dashed line); 10% THF(solid line).

FIG. 3 illustrates the successful deposition of PP2b inside INGE Multibore® (surface area 41 cm²). The UV-Vis spectrum of the liquid medium before (light grey) and after passing PP2b in a 3% THF solvent (grey) and 6% THF solvent (black) through a NADIR type PES supporting membrane.

FIG. 4 illustrates the reduction of membrane fouling by PP2b. As fouling simulants milk powder (black) and humic acids (grey) were examined.

### DETAILED DESCRIPTION OF THE INVENTION

A. General Definitions.

In the context of the present invention a “membrane” generally shall be understood to be a thin, semipermeable porous structure capable of separating two fluids or in particular, separating uncharged molecules and/or ionic components or small particles from a liquid. The membrane acts as a size selective barrier, allowing certain particles, substances or chemicals to pass through while retaining others. If not otherwise stated, a membrane comprises organic polymers as the main components. Such polymer shall be considered the main component of a membrane if it is comprised in an amount of at least 50% by weight, preferably at least 60%, more preferably at least 70%, even more preferably at least 80% and particularly preferably at least 90% by weight of the final membrane.

“Membranes for water treatment” are generally semi-permeable membranes which allow for separation of dissolved and suspended particles of water, wherein the separation process itself can be either pressure-driven or electrically driven.

“Pressure-driven” membrane technologies comprise microfiltration (MF; typical pore size about 0.08 to 2 μm, for separation of very small, suspended particles, colloids, bacteria), ultrafiltration (UF; typical pore size about 0.005 to 0.2 μm; for separation of organic particles>1000 MW, viruses, bacteria, colloids), nanofiltration (NF, typical pore size 0.001 to 0.01 μm, for separation of organic particles>300 MW Trihalomethan (THM) precursors, viruses, bacteria, colloids, dissolved solids) or reverse osmosis (RO, typical pore size 0.0001 to 0.001 μm, for separation of ions, organic substances>100 MW).

“Molecular weights” of polymers are, unless otherwise stated as Mw values, in particular determined via GPC in DMAc. In particular, the GPC measurements were performed with dimethylacetamide (DMAc) containing 0.5 wt-% lithium bromide. Polyester copolymers were used as column material. The calibration of the columns was performed with narrowly distributed PMMA standards. As flow rate 1 ml/min was selected, the concentration of the injected polymer solution was 4 mg/ml.

A “substrate layer” of the present invention also shows a porous structure, is permeable for those constituents that also pass through the “separation layer” and may also be designated as “membrane”. It may also be designated as “carrier” or “carrier membrane” or as a “support”, “support layer”, “support membrane”, or “scaffold layer”. If not otherwise stated such carriers normally have an average pore diameter of 0.5 nm to 1000 nm, preferably 1 to 40 nm, more preferably 10 to 50 nm.

A “separation layer” also designated as “rejection layer”, is attached to and formed on (the outer surface of) the carrier or substrate layer. The separation layer normally is in direct contact with the liquid medium.

A “composite membrane” comprises at least one substrate layer as defined above associated with at least one separation layer as defined above. “Associated with” encompasses any type of interaction between substrate and separation layer, which allows a reversible (in particular by ionic of hydrophobic interactions) or irreversible (in particular by forming covalent chemical bonds) ligation of said two layers. Preferred in the context of the present invention are reversible, non-covalent interactions between substrate and separation layers.

“Flat sheet membranes” show a planar structure and comprise at least one substrate layer and on to a least one separation layer as defined above.

A “hollow fiber membrane” is composed of a substrate in the form of a hollow fiber which in turn carries at its inner or outer surface least one separation layer as defined above. The liquid medium to be treated normally passes through the inside of the fiber

“Multiple channel membranes”, also referred to as multibore membranes, comprise more than one longitudinal channels also referred to simply as “channels”. It may also be considered as bundle of hollow fiber membranes embedded in a carrier or substrate matrix, which forms a porous substrate around said individual channels, through which the liquid medium to be treated passes through.

An “asymmetric membrane” (or anisotropic membrane) has a thin porous or nonporous selective barrier, supported by a much thicker porous substructure (see also H. Susanto, M. Ulbricht, Membrane Operations, Innovative Separations and Transformations, ed. E. Driolo, L. Giorno, Wiley-VCH-Verlag GmbH, Weinheim, 2009, p. 21).

If not otherwise stated herein, a “polyethersulfone” (abbreviated as PES or PESU) in the context of the invention has to be under stood broadly, in not otherwise stated, and is intended to denote any polyethersulfone polymers, each of which is composed of more than about 30, more than about 40, in particular more than about 50 wt. %, preferably more than about 80 wt.-%, and most preferably more than about 90 wt.-% of recurring units that contain at least one ether group (—O—) and at least one sulfone group (—SO₂—). Preferred PES polymers are poly(arylethersulfone) polymers, which, additionally comprise at least one, like 1, 2, 3, 4, 5 or 6, arylene groups in its recurring unit. In addition to said at least one ether group (—O—) and at least one sulfone group (—SO₂—), the recurring unit may also contain at least one thioether (—S—) and/or at least one keto (—C(═O)—) group. Preferred PES polymers are poly(arylethersulfone) polymers, which, contain in their recurring unit arylene groups exclusively linked via ether (—O—) and sulfone (—SO₂—) groups.

A “polyarylene ether” (PAE) as used herein comprises, and preferably is formed from, blocks of the general formula

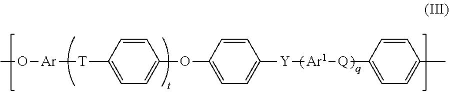

wherein
t and q each independently are 0, 1, 2 or 3,
Ar and Ar¹ each independently an arylene group as defined herein below, preferably having from 6 to 18 carbon atoms.

Q, T and Y each independently a chemical bond or a group selected from —O—, —S—, —SO₂—, S═O, C═O, —N═N—, —CRₐR_{b}— wherein Rₐ and R_{b} are each independently a hydrogen atom or a C₁-C₁₂-alkyl, C₁-C₁₂-alkoxy or C₆-C₁₈-aryl group, or wherein —CRₐR_{b}— also may form a optionally substituted 1,1-cycloalkylidene group; and wherein at least one of Q, T and Y is not —O—. Preferably at least one of Q, T and Y is —SO₂—, and in that case compounds of Formula III represent a particular group of PES or PESU polymers.

For formula III preferred C₁-C₁₂-alkyl groups comprise linear and branched, saturated alkyl groups having from 1 to 12 carbon atoms. Particularly preferred C₁-C₁₂-alkyl groups are C₁-C₆-alkyl radicals such as methyl, ethyl, n-propyl, isopropyl, n-butyl, secbutyl, 2- or 3-methylpentyl and longer-chain radicals such as unbranched heptyl, octyl, nonyl, decyl, undecyl, lauryl, and the singularly or multiply branched analogs thereof.

For formula III preferred C₁-C₁₂-alkoxy groups include the oxy terminated analogs of the above alkyl groups having from 1 to 12 carbon atoms defined above.

For formula III preferred 1,1-cycloalkylidene groups comprise especially C₃-C₁₂-cycloalkylidene radicals, for example cyclopropyliden, cyclobutylidene, cyclopentylidene, cyclohexyliden, cycloheptyliden, cyclooctyliden, and the substituted analogues thereof, carrying 1 or more, like 1, 2, 3, 4, 5 or 6 lower alkyl substituents, in particular methyl or ethyl, preferably methyl substituents.

For formula III preferred C₆-C₁₈-arylene groups Ar and Ar¹ are especially phenylene groups, such as 1,2-, 1,3-and 1,4-phenylene groups, naphthylene groups, for example 1,6-, 1,7-, 2,6- and 2,7-naphthylene, and the arylene groups derived from anthracene, phenanthrene and naphthacene. Preferably, Ar and Ar¹ in the preferred embodiments of formula III are each independently selected from the group consisting of 1,4-phenylene, 1,3-phenylene, naphthylene, especially 2,7-dihydroxynaphthalene, and 4,4′-bisphenylene.

In more general terms “arylene” represents bivalent, mono- or polynucleated, in particular mono-, di- or tri-nucleated aromatic ring groups which optionally may be mono- or poly-substituted, as for example mono-, di- or tri-substituted, as for example by same or different, in particular same lower alkyl, as for example C₁-C₈ or C₁-C₄ alkyl groups, and contain 6 to 20, as for example 6 to 12 ring carbon atoms. Two or more ring groups may be condensed or, more preferably non-condensed rings, or two neighboured rings may be linked via a group R selected from a C—C single bond or an ether (—O—) or an alkylene bridge, or halogenated alkylene bridge or sulfono group (—SO₂—). Arylene groups may, for example, be selected from mono-, di- and tri-nucleated aromatic ring groups, wherein, in the case of di- and tri-nucleated groups the aromatic rings are optionally condensed; if said two or three aromatic rings are not condensed, then they are linked pairwise via a C—C-single bond, —O—, or an alkylene or halogenated alkylene bridge. As examples may be mentioned: phenylenes, like hydroquinone; bisphenylenes; naphthylenes; phenanthrylenes as depicted below:

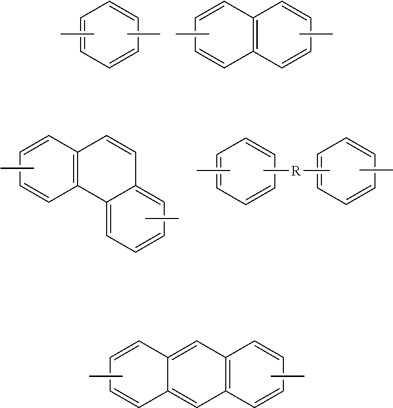

wherein R represents a linking group as defined above like —O—, alkylene, or fluorinated or chlorinated alkylene or a chemical bond and which may be further substituted as defined above.

“Alkylene” represents a linear or branched divalent hydrocarbon group having 1 to 12, 1 to 10, 1 to 8 or 1 to 4 carbon atoms, in particular example C₁-C₄-alkylene groups, like —CH₂—, —(CH₂)₂—, (CH₂)₃—, —(CH₂)₄—, —(CH₂)₂—CH(CH₃)—, —CH₂—CH(CH₃)—CH₂—, (CH₂)₄—.

“Alkyl” represents an residue which is linear or branched having from 1 to 12, 1 to 10, 1 to 8, 1 to 6 or 1 to 4 carbon atoms. Examples thereof are: C₁-C₄-alkyl (or “Lower alkyl”) radicals selected from methyl, ethyl, n-propyl, isopropyl, n-butyl, 2-butyl, isobutyl or tert-butyl, or C₁-C₆-alkyl radicals selected from C₁-C₄-alkyl radicals as defined above and additionally pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl.

A “cycloalkyl” group refers to a saturated aliphatic cyclic hydrocarbon group. The cycloalkyl group has 3-12 carbons, in particular 3-8 carbons, preferably 3-6 carbons, like 3 carbons. The cycloalkyl group may be unsubstituted or substituted by one or more groups selected from halogen, cyano, hydroxy, alkoxy carbonyl, amido, alkylamido, dialkylamido, nitro, amino, alkylamino, dialkylamino, carboxyl, thio and thioalkyl. Non-limiting examples of cycloalkyl group encompass cyclopropyl, cyclobutyl, cyclopentyl, cyclohexyl, and the like. In another embodiment, the cycloalkyl comprises 1-4 rings preferably 1 or 2 most preferably 1 ring.

“Halogen” or “halide” represents F, CI, Br, I.

“Haloalkyl” represents the above identified “alkyl” groups substituted by 1 or more, like 1 to 10, in particular 1 to 5, preferably 1, 2 or 3 identical or different “halogen” residues, in particular F- or Cl-substituents.

“Hydroxyl alkyl” represents the above identified “alkyl” groups substituted by 1 or more, like 1 to 10, in particular 1 to 5, preferably 1, 2 or 3 hydroxyl residues.

“Thioalkyl” represents the above identified “alkyl” groups substituted by 1 or more, like 1 to 10, in particular 1 to 5, preferably 1, 2 or 3 thionly (—SH) residues.

“Phenyl alkyl” represents the above identified “alkyl” groups substituted by 1 or 2, preferably 1 phenyl groups.

“Amino alkyl” represents the above identified “alkyl” groups substituted by 1 or 2, preferably 1 amino (—NH₂) or alkylamino (—NH (lower alkyl) or —N(lower alkyl)₂) groups.

The term “aryl” refers to an aromatic group having at least one carbocyclic aromatic ring, which may be unsubstituted or substituted by one or more groups selected from halogen, cyano, aryl, heteroaryl, haloalkyl, hydroxy, alkoxy carbonyl, amido, alkylamido, dialkylamido, nitro, amino, alkylamino, dialkylamino, carboxy or thio or thioalkyl. Nonlimiting examples of aryl rings are phenyl, naphthyl, and the like. In one embodiment, the aryl group is a 5-12 membered ring, in particular a 5-8 membered ring, preferably 5- or 6 membered ring. In one embodiment, the aryl group is a five membered ring. In one embodiment, the aryl group is a six membered ring. In another embodiment, the aryl group comprises of 2-4, preferably 2 fused rings.

The term “arylalkyl” refers to an alkyl group as defined above substituted by an aryl-group as defined above. Non-limiting examples of arylalkyl are —CH₂Ph or —CH₂CH₂Ph.

The term “heteroaryl” refers to an aromatic group having at least one heterocyclic aromatic ring. In one embodiment, the heteroaryl comprises at least one heteroatom such as sulfur, oxygen, nitrogen, silicon, phosphor or any combination thereof, as part of the ring. In another embodiment, the heteroaryl may be unsubstituted or substituted by one or more groups selected from halogen, aryl, heteroaryl, cyano, haloalkyl, hydroxy, alkoxy carbonyl, amido, alkylamido, dialkylamido, nitro, amino, alkylamino, dialkylamino, carboxy or thio or thioalkyl. Nonlimiting examples of heteroaryl rings are pyranyl, pyrrolyl, pyrazinyl, pyrimidinyl, pyrazolyl, pyridinyl, furanyl, thiophenyl, thiazolyl, indolyl, imidazolyl, isoxazolyl, and the like. In one embodiment, the heteroaryl group is a 5-12 membered ring, in particular a 5-8 membered ring preferably a 5- or 6-membered ring. In one embodiment, the heteroaryl group is a five membered ring. In one embodiment, the heteroaryl group is a six membered ring. In another embodiment, the heteroaryl group comprises of 2-4, in particular 2fused rings. In one embodiment, the heteroaryl group is 1,2,3-triazole. In one embodiment the heteroaryl is a pyridyl. In one embodiment the heteroaryl is a bipyridyl. In one embodiment the heteroaryl is a terpyridyl.

A “heterocyclic” group refers to a saturated or mono- or poly-unsaturated heterocycle. In one embodiment, said heterocycle refers to a ring structure comprising in addition to carbon atoms, sulfur, oxygen, nitrogen, silicon or phosphoror any combination thereof, as part of the ring. In another embodiment the heterocycle is a 3-12 membered ring, in particular a 4-8 membered ring. preferably a 5-7 membered ring. In another embodiment the heterocycle is a 6 membered ring. In another embodiment, the heterocycle group may be unsubstituted or substituted by a halide, haloalkyl, hydroxyl, alkoxy, carbonyl, amido, alkylamido, dialkylamido, cyano, nitro, CO₂H, amino, alkylarnino, dialkylamino, carboxyl, thio and/or thioalkyl. In another embodiment, the heterocycle ring may be fused to another saturated or unsaturated cycloalkyl or heterocyclic 3-8 membered ring. In another embodiment, the heterocyclic ring is a saturated ring. In another embodiment, the heterocyclic ring is an unsaturated ring. The term “carbocyclic ring” refers to a saturated or unsaturated ring composed exclusively of carbon atoms. In one embodiment, the carbocyclic ring is a 3-12 membered ring, in particular 3-8 membered ring. In one embodiment, the carbocyclic ring is a five membered ring. In one embodiment, the carbocyclic ring is a six membered ring. In one embodiment the carbocyclic ring may be unsubstituted or substituted by one or more groups selected from halogen, cyano, haloalkyl, hydroxy, alkoxy carbonyl, amido, alkylamido, dialkylamido, nitro, amino, alkylamino, dialkylamino, carboxy or thio or thioalkyl. Nonlimiting examples of carbocyclic ring are benzene, cyclohexane, and the like. In another embodiment, the carbocyclic ring comprises of 2-4 condensed or non-condensed rings.

The term “PP2b” as used herein refers to a group of chemical compound (5,5′-bis(1-ethylyl-7-polyethylene glycol-N,N′-bis(ethylpropyl)-perylene-3,4,9,10-tetracarboxylic diimde)-2,2′-bipyridine) as represented by the herein identified formula II, wherein the two PEG residues are the same or different, and wherein the chain length of the PEG residues is in the range of 10 to 25 consecutive ethylene glycol moieties. A particular PP2b preparation may uniformly consist of chemical compounds each containing PEG moieties of identical chain length. It may also consist of mixtures of 2 or more, like 2 or 3, preferably 2 compounds of the formula (II) showing different PEG chain lengths, which may be further characterized by stating a mean chain length for the PEG residues.

“Vinyl” has to be understood broadly and encompasses polymerizable monovalent residues of the type C═C—, as for example H₂C═CH— or H₂C═C(methyl)-.

“Mn” represents the number-average molecular weight and is determined in a conventional manner; more particularly, such figures relate to Mn values determined by relative methods, such as gel permeation chromatography with THF as the eluent and polystyrene standards, or absolute methods, such as vapour phase osmometry using toluene as the solvent.

“Mw” represents the weight-average molecular weight and is determined in a conventional manner; more particularly, such figures relate to Mw values determined by relative methods, such as gel permeation chromatography with THF as the eluent and polystyrene standards, or absolute methods, such as light scattering.

The “degree of polymerization” usually refers to the numerical mean degree of polymerization (determination method: gel permeation chromatography with THF as the eluent and polystyrene standards; or GC-MS coupling).

### B. Particular Embodiments

The present invention provides the following particular embodiments:
1. A nanofiltration composite membrane comprising, preferably consisting of
   a) at least one polymeric porous substrate layer (S) comprising at least one substrate layer forming polymer P1, in particular at least one polyarylene ether polymer, preferably at least one polyether sulfone (PES) polymer, and
   b) at least one porous self-assembled supramolecular membrane layer (F) comprising, preferably essentially consisting of, at least one self-assembled perylene diimide deposited on said at least one substrate layer (S).

Preferably said at least one porous substrate layer (S) has a mean pore size in the range of less than 450 or less than 300 nm, in particular 10 to 150, more particular 10 to 100, most preferably 10 to 50 nm.

Preferably said layer (F) is deposited by passing through said porous substrate layer (S) a solution of at least one self-assembling perylene diimide in an aqueous solvent, which contains an organic co-solvent, like in particular THF, in a proportion of more than 0.75 Vol.-%, based on the total volume of the solution, and, more preferably, in a proportion of 1 Vol.-% or more, based on the total volume of the solution.

In another particular embodiment said solution contains the organic co-solvent, like in particular THF, in a proportion of 2 Vol.-% or more, based on the total volume of the solution.

In another preferred embodiment said aqueous solution contains THF as organic cosolvent in a proportion of up to 30 Vol.-%, more particularly in a proportion in a range of 1, 2, 3, 4 or 5 to 30 Vol.-%, preferably 2 to 12 Vol.-%, based on the total volume of the solution.

By adjusting the content of the organic co-solvent the size of the supramolecular structure is adjusted to a value just large enough in order to allow deposition of the membrane building blocks on said substrate layer (S).

“Deposited on” in this context, particularly refers to a reversible deposition of the perylene diimide material on the substrate immobilized on the substrate by non-covalent, as for example ionic, hydrophobic and/or dipolar interaction.

Optionally the thus formed layer (F) may be further subject o a post-deposition treatment by applying an aqueous alkanolic solvent, as described herein below.
2. The composite membrane of embodiment 1, wherein said composite membrane is further characterized by at least one of the following ion retention parameters:
   i) Pb²⁺ retention of at least 5%, in particular at least 7%, preferably at least 10%, preferably in a standardized filtration assay as defined herein below,
   ii) PO₄³⁻ retention of at least 10%, in particular at least 20% preferably at least 40%, preferably in a standardized filtration assay as defined herein below.

“Retention” in this context defines:
a) in one embodiment, if measured by cross-flow filtration, the increase in concentration (in % based on the initial concentration in the liquid medium to be filtered) of a particular ion observed in the retentate of a liquid medium filtered through a composite membrane of the invention; and/or
b) in another embodiment, if measured by dead-end filtration, the concentration (in %) of a particular ion that is missing to 100%, as deduced by subtraction of the concentration (in %) of that particular ion observed in the eluate of a liquid medium filtered through a composite membrane of the invention.

If not otherwise stated definition b) preferably applies.
3. The composite membrane of embodiment 1 or 2, further characterized by a flux in the range of 10 to 80 L/m²/bar/h, preferably 20 to 50 L/m²/bar/h, as determined under standardized conditions.
4. The composite membrane of one of the preceding embodiments, wherein said at least one self-assembled supramolecular membrane layer (F) is non-covalently attached on said at least one substrate layer (S), as for example by ionic, hydrophobic and/or dipolar interaction.
5. The composite membrane of one of the preceding embodiments, wherein said at least one self-assembled supramolecular membrane layer (F) has a mean pore size in the range of 0.001 to 0.01 μm (1 to 10 nm), preferably 2 to 5 nm.
6. The composite membrane of embodiment 3, wherein said at least one self-assembled supramolecular membrane layer (F) has a pore size distribution which allows the separation of multivalent inorganic cations, in particular multivalent metal cations, multivalent inorganic anions, in particular phosphate anions, and/or organic molecules of molar mass between 100 and 100,000 g/mol, preferably between 1000 and 10,000 g/mol., dissolved in an aqueous medium.
7. The composite membrane of one of the preceding embodiments, wherein said at least one porous substrate layer (S) has a mean pore size in the range of 10 to 1000 nm, preferably less than 450 or less than 300 nm, in particular 10 to 150, more particular 10 to 100, most preferably 10 to 50 nm.
8. The composite membrane of one of the preceding embodiments, wherein said at least one self-assembled perylene diimide, comprises a perylene diimide of the following general Formula I or a salt or metal complex thereof:

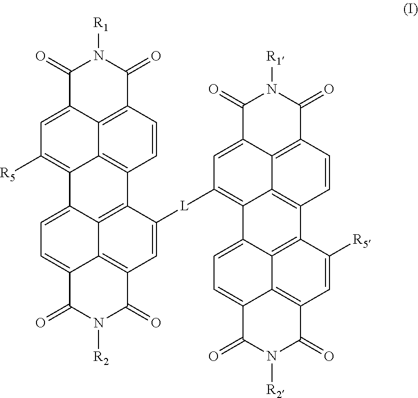

wherein
R₁ and R₁′ are each independently [(CH₂)_{q}O]ᵣCH₃, [(CH₂)_{q}O]ᵣH [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si—A, or [C(O)CHR₃NH]ₚH wherein said aryl or heteroaryl groups are optionally substituted by 1-3 groups comprising halide, CN, CO₂H, OH, SH, NH₂, CO₂-(C₁-C₆ alkyl) or O-(C₁-C₆ alkyl); wherein A comprises three same or different of the following substituents Cl, Br, I, O-(C₁-C₈)alkyl or (C₁-C₈)alkyl; and wherein R₃ in said [C(O)CHR₃NH]pH is an alkyl, haloalkyl, hydroxyalkyl, hydroxyl, aryl, phenyl, phenylalkyl, aminoalkyl and independently the same or different when p is larger than 1;
R₂ and R₂′ are each independently [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣ(CH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si—A, or [C(O)CHR₄NH]ₛH wherein said aryl or heteroaryl groups are optionallysubstituted by 1-3 groups comprising halide, CN, CO₂H, OH, SH, NH₂, CO₂-(C₁-C₆ alkyl)or O-(C₁-C₆ alkyl); wherein A comprises three same or different of the followingsubstituents Cl, Br, I, O(C₁-C₈)alkyl or C₁-C₈)alkyl; and wherein R₄ in said [C(O)CHR₄NH]ₛH is an alkyl, haloalkyl, hydroxyalkyl, hydroxyl, aryl, phenyl, phenylalkyl, aminoalkyl and independently the same or different when s is larger than 1;
R₅ and R₅′ are each independently H, —ORₓ where Rₓ is C₁-C₆ alkyl, [(CH₂)ₙO]ₒCH₃ or [(CH₂)ₙO]ₒH; [(CH₂)ₙC(O)O]ₒCH₃, [(CH₂)ₙC(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)ₙO]ₒCH₃, [(alkylene)ₙC(O)ₒ]CH₃, [(alkylene)ₙC(O)NH]ₒCH₃, [(alkylene)ₙCH₂═CH₂]ₒCH₃, [(alkylene)ₙCH≡CH]ₒCH₃, [(alkylene)ₙNH]ₒCH₃, aryl, heteroaryl, C≡C-R₇, CH═CR₈R₉, NR₁₀R₁₁, chiral group, amino acid, peptide or a saturated carbocyclic or heterocyclic ring wherein said saturated heterocyclic ring or heteroaryl contains at least one nitrogen atom and R₅ or R₅′ are connected via the nitrogen atom and wherein said saturated carbocyclic ring, heterocyclic ring, aryl and heteroaryl groups are optionally substituted by 1-3 groups comprising halide, aryl, heteroaryl, CN, CO₂H, OH, SH, NH₂, CO₂-(C₁-C₆ alkyl) or O-C₁-C₆ alkyl);
R₇ is H, halo, C₁-C₃₂)alkyl, aryl, NH₂, alkyl-amino, COOH, C(O)H, alkyl-COOH heteroaryl, Si(H)₃ or Si[C₁-C₈)alkyl]₃ wherein said aryl or heteroaryl groups are optionally substituted by 1-3 groups comprising halide, aryl, heteroaryl, CN, CO₂H, OH, SH, NH₂, CO₂-C₁-C₆ alkyl) or O-C₁-C₆ alkyl); R₈, R₉, R₁₀ and R₁₁ are each independently H, C₁-C₃₂)alkyl, aryl, NH₂, alkylamino, COOH, C(O)H, alkyl-COOH or heteroaryl wherein said aryl or heteroaryl groups are optionally substituted by 1-3 groups comprising halide, CN, CO₂H, OH, SH, NH₂, CO₂-C₁-C₆ alkyl) or O-C₁-C₆ alkyl);
L is a linker;
n is an integer from 1-5;
o is an integer from 1-100;

p is an integer from 1-100;
q is an integer from 1-5;
r is an integer from 1-100; and
s is an integer from 1-100;
wherein if R₅ and/or R₅′ are chiral; said membrane will form a chiral membrane.
9. The composite membrane of one of the preceding embodiments, wherein in compounds of formula I
L is selected from linkers of the formulae (a) to (f),

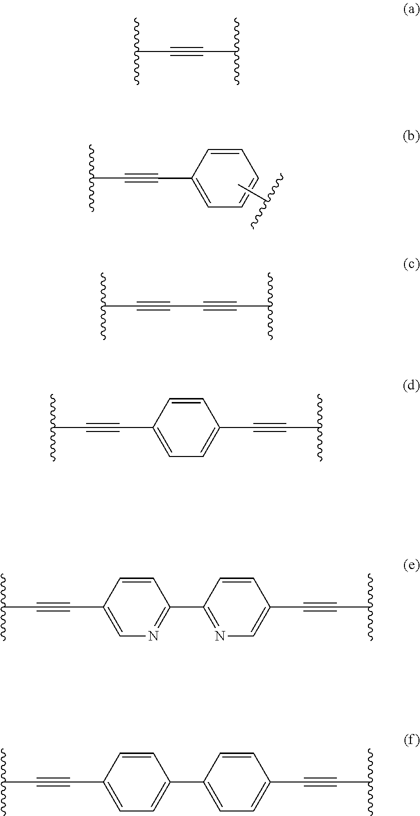

preferably (e) or (f)
R1 and R1′ are each independently (C₁-C₃₂)alkyl, preferably (C₃-C₁₀)alkyl,
R2 and R2′ are each independently (C₁-C₃₂)alkyl, preferably (C₃-C₁₀)alkyl,
R5 and R5′ are each independently [(CH₂)ₙO]ₒCH₃ or [(CH₂)ₙO]ₒH;
n is an integer from 1-5, preferably 2 or 3; and
o is an integer from 5-50, preferably 5 to 35.
10. The composite membrane of one of the preceding embodiments, wherein said perylene diimide is of the Formula II:

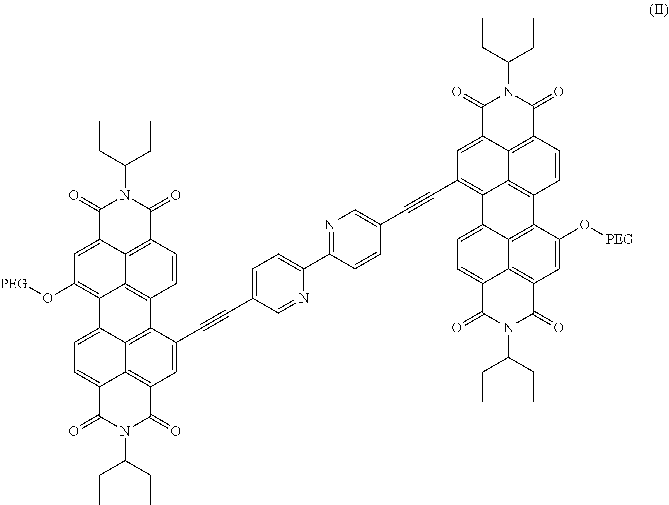

wherein PEG represents a polyethylene glycol residue comprising 10 to 25 consecutive ethylene glycol units (PEG10 to PEG25), or a mixture of at least two of said compounds, in particular a mixture, of a PEG13- and a PEG17-perylene diimide; wherein the mixing ratio of said two different PEG perylene diimdes is in the range of 1:100 to 100:1, preferably 1:20 to 20:1.
Non-limiting examples of suitable mixtures are
   5% PP2b PEG 13+95% PP2b PEG 17 and
   95% PP2b PEG 13+5% PP2b PEG 23 (wt.-% each)
11. The composite membrane of one of the preceding embodiments, wherein at least one porous substrate layer (S) is a polyarylene ether based, in particular polyethersulfone-based layer.
12. The composite membrane of embodiment 11, wherein said porous substrate layer (S) comprises a polyarylene ether-based polymer (P1) comprising a repeating unit of formula (Ill)

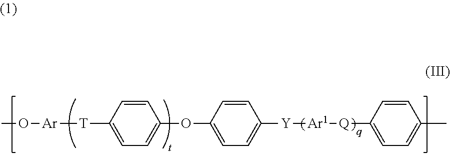

wherein
t and q each independently are 0, 1, 2 or 3,
Ar and Ar¹ each independently are an arylene group;
Q, T and Y each independently are a chemical bond or a group selected from —O—, —S—, —SO₂—, S═O, C═O, —N═N—, —CRₐR_{b}— wherein Rₐ and R_{b} are each independently a hydrogen atom or a C₁-C₁₂-alkyl, C₁-C₁₂-alkoxy or C₆-C₁₈-aryl group, or wherein —CRₐR_{b}— also may form a 1,1-cycloalkylidene group; and wherein at least one of Q, T and Y is not —O—. Preferably at least one of Q, T and Y is —SO₂—.
13. The composite membrane of one of the preceding embodiments, wherein said polymer (P1), in particular said polyethersulfone-based polymer, has a Mw in the range of 50.000 to 150.000, in particular 70.000 to 100.000 g/mol, as determined by Gel Permeation Chromatography (GPC) in N-dimethylacetamide (DMAc).
14. The composite membrane of one of the preceding embodiments, wherein the membrane layer (F) deposited on top of the substrate layer (S) has a layer thickness in the range of at least 0.1 g/m² (mass of (F) per area of (S)), like 0.1 to 10 g/m² preferably 1 to 6, most preferably 2 to 4 g/m².
15. The composite membrane of one of the preceding embodiments, a) in the form of a flat sheet, or b) in the form of a multibore hollow fibre.

In one particular embodiment of the invention, composite membranes are present as spiral wound membranes, as pillows or flat sheet membranes.

In another embodiment of the invention, composite membranes are present as tubular membranes.

In another embodiment of the invention, composite membranes are present as hollow fiber membranes or capillaries.

In yet another embodiment of the invention, composite membranes are present as single bore hollow fiber membranes.

In yet another, preferred embodiment of the invention, composite membranes are present as multibore hollow fiber membranes.

Multiple channel membranes, also referred to as multibore membranes, comprise more than one longitudinal channels also referred to simply as “channels”.

In a preferred embodiment, the number of channels is typically 2 to 19. In one embodiment, multiple channel membranes comprise two or three channels. In another embodiment, multiple channel membranes comprise 5 to 9 channels. In one preferred embodiment, multiple channel membranes comprise seven channels.

In another embodiment the number of channels is 20 to 100.

The shape of such channels, also referred to as “bores”, may vary. In one embodiment, such channels have an essentially circular diameter. In another embodiment, such channels have an essentially ellipsoid diameter. In yet another embodiment, channels have an essentially rectangular diameter. In some cases, the actual form of such channels may deviate from the idealized circular, ellipsoid or rectangular form.

Normally, such channels have a diameter (for essentially circular diameters), smaller diameter (for essentially ellipsoid diameters) or smaller feed size (for essentially rectangular diameters) of 0.05 mm to 3 mm, preferably 0.5 to 2 mm, more preferably 0.9 to 1.5 mm. In another preferred embodiment, such channels have a diameter (for essentially circular diameters), smaller diameter (for essentially ellipsoid diameters) or smaller feed size (for essentially rectangular diameters) in the range from 0.2 to 0.9 mm.

For channels with an essentially rectangular shape, these channels can be arranged in a row.

For channels with an essentially circular shape, these channels are in a preferred embodiment arranged such that a central channel is surrounded by the other channels. In one preferred embodiment, a membrane comprises one central channel and for example 4, 6 or 18 further channels arranged cyclically around the central channel.

The wall thickness in such multiple channel membranes is normally from 0.02 to 1 mm at the thinnest position, preferably 30 to 500 μm, more preferably 100 to 300 μm.

Normally, such multiple channel membranes according to the invention have an essentially circular, ellipsoid or rectangular diameter. Preferably, such multiple channel membranes according to the invention are essentially circular. In one preferred embodiment, such multiple channel membranes according to the invention have a diameter (for essentially circular diameters), smaller diameter (for essentially ellipsoid diameters) or smaller feed size (for essentially rectangular diameters) of 2 to 10 mm, preferably 3 to 8 mm, more preferably 4 to 6 mm. In another preferred embodiment, such multiple channel membranes according to the invention have a diameter (for essentially circular diameters), smaller diameter (for essentially ellipsoid diameters) or smaller feed size (for essentially rectangular diameters) of 2 to 4 mm.

In one embodiment the rejection layer is located on the inside of each channel of said multiple channel membrane.
16. The composite membrane of one of the preceding embodiments, in the form of a) a flat sheet or b) in tubular form, wherein the self-assembled supramolecular membrane layer (F) is deposited on the inner surface of the tubular substrate (S).
17. A method of preparing a composite membrane of any one of the preceding embodiments, which method comprises
   a) providing at least one porous substrate layer (S), preferably comprising at least one polymer (P1), preferably polyarylene ether, more preferably PES polymer
   b) providing a solution of at least one self-assembling perylene diimide in an aqueous solvent containing an organic co-solvent, preferably THF, in a proportion suitable for reducing the molecular weight of the supramolecular perylene diimide structures;
   c) passing said solution of step b) through the porous substrate layer of step a), thereby depositing said at least one self-assembled perylene diimide from said solution onto said substrate layer (S) to form at least one porous self-assembled supramolecular membrane (F), optionally followed by washing the deposited membrane with an aqueous liquid, preferably water, and preferably maintaining said membrane in said aqueous liquid; and
   e) optionally repeating steps b) and c) with the same solution or a solution with different, preferably higher, proportion of an organic, preferably the same, cosolvent.
18. The method of embodiment 17, wherein in step b) a solution of at least one self-assembling perylene diimide in an aqueous solvent is applied, which contains said said organic co-solvent in an amount sufficient to increase the proportion of lower molecular weight supramolecular fibrils with a molecular mass in the range of 10.000 to 1.000.000 g/mol to a value in the range of 10% to 100%, in particular 15% to 60%.
19. The method of anyone of the embodiments 17 to 18, wherein in step b) a solution of at least one self-assembling perylene diimide in an aqueous solvent is applied, which contains THF as said organic co-solvent in a proportion of more than 0,75 Vol.-%, in particular in a range of 1 to 30 Vol.-%, preferably 1, 2, 3, 4 or 5 to 15 Vol.-%, more preferably in a range of 2 to 12 Vol.-%, based on the total volume of the solution.
20. The method of anyone of the embodiments 17 to 19, wherein additionally d) the at least one deposited porous self-assembled supramolecular membrane (F) is subjected to a post-deposition treatment by applying (for example by incubating with and/or passing through, preferably by passing through at pressures below 5 bar) an aqueous-alkanolic solvent, in particular a water/ethanol mixture having an ethanol content in a proportion of 25 to 75 Vol.-%, based on the total volume of the solvent mixture, to said deposited membrane.

As illustrated in the subsequent experimental section, in particular Tables 2, 3 and 6, said post-deposition treatment (densification) results in a systematic increase of retention of the obtained membrane structure.
21. A method of separation/filtration/purification of metal cations, in particular multivalent metal cations, or heavy metal cations, in particular multivalent heavy metal cations, as for example multivalent ions of Ni, Cr, Zn, Pb, Gd, Ca, and/ or inorganic anions, in particular phosphate ions, which method comprises passing an aqueous medium containing at least one of said ions through a nanofiltration composite membrane as defined in one of the embodiments 1 to 16 or prepared by a method of one of the embodiments 17 to 20, thereby obtaining an aqueous filtrate depleted from at least one of said ions and a retentate enriched with at least one of said ions.

If not otherwise defined, the term “metal cations” encompasses any metal cation of any metal selected from the groups 1 to 16, in particular groups 2 to 14 (IUPAC 1985) of the periodic system of chemical elements.

If not otherwise defined, the term “heavy metal cations” encompasses any cation derived from a metal having a density of more than 5.0 g/cm³.

If not otherwise defined, the term “inorganic anions”, defines any inorganic anion, in particular oxidic anions, of a post-transition metal (like Al, Ga, In, TI, Sn, Pb, Bi, Po), metalloid (like Si, Ge, As, Sb, Te, At) or non-metal (like P, S, Se, N, CI, Br, I) element of groups 13 to 17, in particular groups 14 to 16 (IUPAC 1985) of the periodic system of chemical elements.
22. The method of embodiment 20 applied in waste water treatment.
23. A method of separation/filtration/ of water soluble organic molecules (like dyes, like methylene blue) which method comprises passing an aqueous medium containing at least one of said organic molecules through a nanofiltration composite membrane as defined in one of the embodiments 1 to 16 or prepared by a method of one of the embodiments 17 to 20, thereby obtaining an aqueous filtrate depleted from at least one dye and a retentate enriched with at least one of said dye.
24. The method of one of the embodiments 17 to 20 performed with a nanofiltration composite membrane in the form of a flat sheet or in tubular form or in multi-bore tubular form.
25. A filter cartridge comprising at least one composite membrane of one of the preceding embodiments 1 to 16, in the form of a) a flat sheet or b) in tubular form, wherein the self-assembled supramolecular membrane layer (F) is deposited on the inner surface of the tubular substrates (S).
26. A filtration device comprising at least one filter cartridge of embodiment 25.
27. The method or device or cartridge of anyone of the embodiments 21 to 26, wherein the composite membrane as applied therein is characterized by a permeance 1 to 200 L/m²/h/bar, preferably 10 to 50 L/m²/h/bar.

“Passing through” as used herein encompasses both cross-flow and dead-end flow methods.

### C. Further Embodiments of the Invention

### 1. Preparation of Membrane Substrate Layer (S)

The manufacture of membranes such as NF membranes and their use in filtration modules of different configuration is known in the art. See for example M C Porter et al. in Handbook of Industrial Membrane Technology (William Andrew Publishing/Noyes, 1990).

### 1.1 General

The at least one substrate or carrier layer (S) as used in the composite membranes of the invention, are in principle of a type which is well known in the art or may be prepared by applying well-known techniques of substrate layer formation

As the main component an organic polymer (P1) is applied for preparing the layer (S).

Suitable polymers (P1) applicable for this purpose are well known in the art. In particular, there may be mentioned polyarylenes ether, polysulfones (PSU), polyethersulfones (PESU), polyphenylenesulfones (PPSU), polyamides (PA), polyvinylalcohols (PVA), cellulose acetates (CA), cellulose triacetates (CTA), CA-triacetate blends, cellulose ester, cellulose nitrates, regenerated cellulose, aromatic, aromatic/aliphatic or aliphatic polyamides, aromatic, aromatic/aliphatic or aliphatic polyimides, polybenzimidazoles (PBI), polybenzimidazolones (PBIL), polyacrylonitrils (PAN), PAN-poly(vinyl chloride) copolymers (PAN-PVC), PAN-methallyl sulfonate copolymers, poly(dimethylphenylene oxide) (PPO), polycarbonates, polyesters, polytetrafluroethylenes (PTFE), poly(vinylidene fluorides) (PVDF), polystyrenes, polypropylenes (PP), polyelectrolyte complexes, poly(methyl methacrylates) PMMA, polydimethylsiloxanes (PDMS), aromatic, aromatic/aliphatic or aliphatic polyimidourethanes, aromatic, aromatic/aliphatic or aliphatic polyamidimides, crosslinked polyimides or mixtures thereof.

Preferably substrate or carrier layer(s) (S) comprise as the main polymer component a polymer selected from polysulfone, polyethersulfone, PVDF, polyimide, polyamidimide, crosslinked polyimides, polyimide urethanes, cellulose acetate or mixtures thereof. Particularly preferred carrier layer(s) (S) comprise as the main polymer component at least one polyethersulfone, optionally in admixture with at least one further polymer, selected from polysulfone, PVDF, polyimide, polyamidimide, crosslinked polyimides, polyimide urethanes, cellulose acetate or mixtures thereof. Most preferred carrier layer(s) (S) essentially consist of one or polyethersulfones as the single main polymer constituent. Said polymer has to be soluble in suitable organic solvents, such as N-methylpyrrolidone, in order to form a castable or extrudable polymer solution from which, upon coagulation a porous membrane structure may be formed.

Suitable polymers, in particular polyarylene ethers, more particular PES polymers, preferably have a mean molecular weight Mn (number average) in the range from 2.000 to 70.000 g/mol, especially preferably 5.000 to 40.000 g/mol and particularly preferably 7.000 to 30.000 g/mol. Preferably such polymers have a polydispersity (Mw/Mn) from 1.5 to 5, more preferably 2 to 4.

In one embodiment, substrate or carrier layer(s) (S) comprise at least one further additive like polyvinylpyrrolidones (PVP), polyethylene glycols (PEG), amphiphilic block copolymers or triblock copolymers like PEG- PPO (polypropyleneoxide)-PEG.

Non-limiting examples of suitable PVPs are
Luvitec® K90 Polyvinylpyrrolidone with a solution viscosity characterized by the K-value of 90, determined according to the method of Fikentscher (Fikentscher, Cellulosechemie 13, 1932 (58))
Luvitec® K30 Polyvinylpyrrolidone with a solution viscosity characterized by the K-value of 30, determined according to the method of Fikentscher (Fikentscher, Cellulosechemie 13, 1932 (58))

In a preferred embodiment, substrate or carrier layer(s) (S) comprise as major components polysulfones or polyethersulfone in combination with polyvinylpyrrolidone as a further additive.

In one preferred embodiment, substrate or carrier layer(s) (S) comprise 80 to 50% by weight of polyethersulfone and 20 to 50%by weight of polyvinylpyrrolidone.

In another embodiment, substrate or carrier layer(s) (S) comprise 99 to 80% by weight of polyethersulfone and 1 to 20% by weight of polyvinylpyrrolidone.

In one preferred embodiment, substrate or carrier layer(s) (S) comprise 99.9 to 50% by weight of a combination of polyethersulfone and 0.1 to 50% by weight of polyvinylpyrrolidone.

In another embodiment substrate or carrier layer(s) (S) comprise 95 to 80% by weight of and 5 to 15% by weight of polyvinylpyrrolidone.

In another embodiment the substrate or carrier layer(s) (S) may comprise organic or inorganic particles in the nanometer size range, such as zeolite particles, in order to increase the membrane porosity and/or hydrophilicity. This can for example be achieved by including such nanoparticles in the dope solution for the preparation of said support layer.

Suitable substrate or carrier layer(s) (S) are either in the form of flat sheets, for example in the size range of at least 0.5 cm², as for example 0.5 to 50 cm²; The layer thickness may be in the range of 0.2 to 10 mm in particular 0.7 to 3 mm.

### 1.2 Preparation of Sheet-Like Substrate Layer (S)

In one embodiment the substrate layer is a conventional sheet like structure.

Preparation of the sponge-like substrate layer (S) is performed by applying well-known techniques of membrane formation, as for example described in C. A. Smolders et al J. Membr. Sci.: Vol 73, (1992), 259.

A particular method of preparation is known as phase separation method.

In a first step the polymer (P1), as for example the PES prepared as described herein is dried, as for example at a temperature in the range of 20 to 80, as for example 60° C. under vacuum in order to remove excess liquid.

In a second step a homogeneous dope solution (D) comprising the polymer (P1) in a suitable solvent system is prepared. Said solvent system contains at least one solvent selected from N-methylpyrrolidone (NMP), N-dimethylacetamide (DMAc), dimethylsulfoxide (DMSO), dimethylformamide (DMF), triethylphosphate, tetrahydrofuran (THF), 1,4-dioxane, methyl ethyl ketone (MEK), or a combination thereof; and, additionally may contain at least one further additive selected from ethylene glycol, diethylene glycol, polyethylene glycol, glycerol, methanol, ethanol, isopropanol, polyvinylpyrrolidone, or a combination thereof, wherein said additive is contained in said polymer solution in a range of 0-50, like 0-30 wt.-% per total weight of the polymer solution.

The polymer content is in the range of 10 to 40, or 16 to 24 wt.-% based on the total weight of the solution.

In a third step, the polymer solution is then cast on a solid support, as for example glass plate using a casting knife suitably of applying a polymer layer of sufficient thickness.

Immediately afterwards, in a fourth step, the polymer layer provided on said support is immersed in a coagulant bath, containing a water-based coagulation liquid, e.g. a tap water coagulant bath. Optionally, water may be applied in admixture with at least one lower alcohol as coagulant bath, in particular methanol, ethanol, isopropanol, and optionally in admixture with at least one solvent as defined above. The as-cast membranes were soaked in water for at least 2 days with constant change of water to ensure complete removal of solvent in order to induce phase inversion.

As a result of this procedure a membrane substrate exhibiting a sponge-like structure is obtained.

In another embodiment a process for making membrane substrate layers S comprises the following steps:

In step a) a dope solution (D) is provided comprising at least one polymer (P1) and at least one solvent (L)

In step b), at least coagulant (C) is added to said dope solution (D). Thereby, said at least one polymer (P1) is coagulated to obtain membraneS.

Coagulants (C) have lower solubility of polymer (P1) than solvent (L). Suitable coagulants© comprise for example liquid water, water vapor, alcohols or mixtures thereof. In one embodiment coagulants (C) are liquid water, water vapor, alcohols or mixtures thereof.

Preferably alcohols suitable as coagulants (C) are mono-, di- or trialkanols bearing no further functional groups. Examples are iso-propanol, ethylene glycol or propylene glycol.

In a further embodiment the manufacturing of membranes substrates S includes non-solvent induced phase separation (NIPS).

In said NIPS process, the polymers (P1) used as starting materials are dissolved in at least one solvent (L) together with any additive(s) used. In a next step, a porous polymeric membrane is formed under controlled conditions in a coagulation bath. In most cases, the coagulation bath contains water as coagulant (C), or the coagulation bath is an aqueous medium, wherein the matrix forming polymer is not soluble. The cloud point of the polymer is defined in the ideal ternary phase diagram. In a bimodal phase separation, a microscopic porous architecture is then obtained, and water soluble components (including polymeric additives) are finally found in the aqueous phase.

In case further additives like second dope polymers (DP2) are present that are simultaneously compatible with the coagulant (C) and the matrix polymer(s), segregation on the surface results. With the surface segregation, an enrichment of the certain additives is observed. The membrane surface thus offers new (for example hydrophilic) properties compared to the primarily matrix-forming polymer, by said phase separation induced enrichment of the additive.

In another embodiment of the invention a typical process for the preparation of a solution for membrane substrate (S) preparation is characterized by the following steps:
a1) Providing a dope solution (D) comprising at least one polymer (P1) and at least one solvent (L),
a2) Adding further additives like pore forming additives such as PVP, PEG, sulfonated PESU or mixtures thereof,
a3) Heating the mixture until a viscous solution is obtained; typically temperature of the dope solution (D) is 5-250 ° C., preferably 25-150 ° C., more preferably 50-90 ° C.
a4) Stirring of the solution/suspension until a mixture is formed within 1-15 h, typically the homogenization is finalized within 2 h.
b) Casting the membrane dope in a coagulation bath to obtain a membrane structure. Optionally the casting can be done using a polymeric support (non-woven) for stabilizing the membrane structure mechanically.

Optionally processes of membrane layer (S) preparation according to the invention as described herein above as well as in the following section can be followed by further process steps. For example such processes may include c) oxidative treatment of the membrane (S) previously obtained, for example using sodium hypochlorite. Such processes are for example described in I. M. Wienk, E. E. B. Meuleman, Z. Borneman, Th. Van den Boomgaard, C. A. Smoulders, Chemical Treatment of Membranes of a Polymer Blend: Mechanism of the reaction of hypochlorite with poly(vinylpyrrolidone), Journal of Polymer Science: Part A: Polymer Chemistry 1995, 33, 49-54.

Processes according to the invention as described herein above as well as in the following section may further comprise d) washing of the membrane with water.

### 1.3 Preparation of Multiple Channel Substrate Layers

Particularity preferred are substrate or carrier layer(s) (S) in the form of a multiple channel membrane, either in the form of a flat (two-dimensional) sheet containing side-by-side arranged multiple parallel channels in which the active separation layer is arranged in the channels. Said channels are embedded in a porous matrix of said polymer material. Said sheets may be wound in the form of a spiral thus forming a three-dimensional structure.

Most preferred are cylindrical substrate or carrier layer(s) (S) in which the active separation layer is arranged in the channels and which parallel channels are arranged in a bundle surrounded by the porous polymeric matrix material. Thereby a significant increase of surface area of the channels relative to the outer surface area of the cylindrical structure is obtained.

Suitable multiple channel membrane carriers can for example be obtained using extrusion processes as disclosed in U.S. Pat. No. 6,787,216 B1, col. 2, In. 57 to col. 5, In. 58, incorporated herein by reference. They are also commercially available from Inge GmbH Germany, and commercialized under the trade name Multibore O. As examples there may be mentioned:

“Inge Multibore® membranes 0.9” with an average diameter of 0.9 mm per channel and an outer membrane diameter of 4.0 mm.

“Inge Multibore® membranes 1.5” with an average diameter of 1.5 mm per channel and an outer membrane diameter of 6.0 mm.

In a preferred embodiment the membrane material for the manufacture of such multiple channel membranes are soluble thermoplastic polymer. Examples are polysulfones, poly (ether sulfones), polyvinylidene chloride, polyvinylidene fluoride, polyvinyl chloride, polyacrylonitrile, etc.

The polymer is dissolved prior to extrusion in a usual solvent and additives like PVP, or nanoparticles, can be added. A usual solvent is N-methylpyrrolidone. Cosolvents may be added, as for example glycerol.

The polymer solution is extruded through a extrusion nozzle with internal hollow needles to form a cylindrical structure containing the desired number of internal channels. Through said hollow needles a coagulating agent is injected into the extruded polymer solution in order to obtain the channels. The outer surface of the extruded structure is contacted with a coagulation agent in order to form and stabilize the outer shape of the desired porous structure.

Coagulation agents are known to the expert. Many coagulation agents suitable for the present purpose are non-solvents for the polymer that are miscible with the solvent as applied for preparing the polymer solution. The choice for the non-solvent depends on the polymer and the solvent. A common solvent is N-methylpyrrolidone. Examples of non-solvents for use with this solvent are dimethylformamide, dimethyl sulfoxide and water. The skilled reader can adjust the strength of the coagulation agent by the choice of the combination solvent/non-solvent and the ratio of solvent/non-solvent.

It is also well-known to a person of ordinary skill in the art, that the pore size of the carrier can be specifically adjusted by variation of the coagulation conditions (strength of the coagulation system). In this way it is also possible to generate a pore size gradient, for example with smaller pores on the active inner surface of an internal channel, which is in direct contact with the liquid medium to be treated, and a larger pore size on the opposite side, as for example the outer surface of the substrate, like the cylindrical multibore membrane. Suitable techniques for adjusting the pore size are well known to a skilled reader. The strength of the coagulation may be adjusted by the combination of non-solvent(s)/solvent(s) and adapting their ratio. Coagulation solvent systems are known to the person skilled in the art and can be adjusted by routine experiments.

It is also possible to form an additional separating layer by applying a coating in the channels. Coating materials usual to that end are known to the expert. A survey of suitable coating materials is given by Robert J. Petersen in Journal of Membrane Science 83 , 81-150 (1993). A preferred inner coating is described in more detail below.

The diameter of the channels of the multiple channel membranes of the invention is between 0.1 and 8 mm and preferably between 0.1 and 6 mm. The thickness of the walls is adjusted to the pressure to be exerted in the channels depending on the intended use. In general, the thickness of the walls is between 0.05 and 1.5 mm and preferably between 0.1-0.5 mm. The cylindrical membranes contain at least four and preferably 7 to 19 channels. The diameter of the cylindrical membrane generally is between 1 to 20 mm and preferably between 2 and 10 mm.

### 1.4. Preparation of PES Polymers

Unless otherwise stated, preparation of polymers is generally performed by applying standard methods of polymer technology. In general, the reagents and monomeric constituents as used herein are either commercially available or well known from the prior art or easily accessible to a skilled reader via disclosure of the prior art.

In general, the preferred polyarylene ether sulfone (PES) polymer P1 can be synthesized, for example by reacting a dialkali metal salt of an aromatic diol and an aromatic dihalide as taught, for example by R. N. Johnson et al., J. Polym. Sci. A-1, Vol. 5, 2375 (1967).

Examples of suitable aromatic dihalides (M1) include: bis(4-chlorophenyl)sulfone, bis(4-fluorophenyl) sulfone, bis(4-bromophenyl) sulfone, bis(4-iodophenyl) sulfone, bis(2-chlorophenyl) sulfone, bis(2-fluorophenyl) sulfone, bis (2-methyl-4-chlorophenyl) sulfone, bis(2-methyl-4-fluorophenyl) sulfone, bis(3,5-dimethyl-4-chlorophenyl) sulfone, bis(3,5-dimethyl-4-flurophenyl) sulfone and corresponding lower alkyl substituted analogs thereof. They may be used either individually or as a combination of two or more monomeric constituents thereof. Particular examples of dihalides are bis(4-chlorophenyl) sulfone (also designated (4,4′-dichlorophenyl) sulfone; DCDPS) and bis(4-fluorophenyl) sulfone.

Examples of suitable dihydric aromatic alcohols (M2) which are to react with the aromatic dihalide are: hydroquinone, resorcinol, 1,5-dihydroxynaphthalene, 1,6-dihydroxynaphthalene, 1,7-dihydroxynaphthalene, 2,7-dihydroxynaphthalene, 4,4′-bisphenol, 2,2′-bisphenol, bis(4-hydroxyphenyl) ether, bis(2-hydroxyphenyl) ether, 2,2-bis(4-hydroxyphenyl)propane, 2,2-bis(3-methyl-4-hydroxy-phenyl)propane, 2,2-bis(3,5-dimethyl-4-hydroyphenyl)propane, bis(4-hydroxyphenyl)methane, and 2,2-bis(3,5-dimethyl-4-hydroxypenyl)hexafluoropropane. Preferred of them are hydroquinone, resorcinol, 1,5-dihydroxynaphthalene, 1,6-dihydroxynaphthalene, 1,7-dihydroxynaphthalene, 2,7-dihydroxynaphthalene, 4,4′-biphenol, bis(4-hydroxyphenyl) ether, and bis(2-hydroxyphenyl) ether. They may be used either individually or as a combination of two or more monomeric constituents M2a. Particular examples of such dihydric aromatic alcohols are 4,4′-bisphenol and 2,2′-bisphenol.

The dialkali metal salt of said dihydric aromatic phenol is obtainable by the reaction between the dihydric aromatic alcohol and an alkali metal compound, such as potassium carbonate, potassium hydroxide, sodium carbonate or sodium hydroxide.

The reaction between the dihydric aromatic alcohol dialkali metal salt and the aromatic dihalide is carried out as described in the art (see for example [Harrison et al, Polymer preprints (2000) 41 (2) 1239).] Harrison et al, Polymer preprints (2000) 41 (2) 1239).

For example a in a polar solvent such as dimethyl sulfoxide, sulfolane, N-methyl-2-pyrrolidone, 1,3-dimethyl-2-imidazolidinone, N,N-dimethylformamide, N,N-dimethylacetamide, and diphenyl sulfone, or mixtures thereof or mixtures of such polar solvents with apolar organic solvents like toluene may be applied.

The reaction temperature is typically in the range of 140 to 320° C., preferentially 160 to 250° C. The reaction time may be in the range of 0.5 to 100 h, preferentially 2 to 15 h.

The use of either one of the dihydric aromatic alcohol alkali metal salt and the aromatic dihalide in excess results in the formation of end groups that can be utilized for molecular weight control. Otherwise, if the two constituents are used in equimolar amounts, and either one of a monohydric phenol, as for example, phenol, cresol, 4-phenylphenol or 3-phenylphenol, and an aromatic halide, as for example 4-chlorophenyl sulfone, 1-chloro-4-nitrobenzene, 1-chloro-2-nitrobenzene, 1-chloro-3-nitrobenzene, 4-fluorobenzophenone, 1-fluoro-4-nitrobenzene, 1-fluoro-2-nitrobenzene or 1-fluoro-3-nitrobenzene is added for chain termination.

Non-limiting examples of suitable repeating units of the general formula III are as follows:

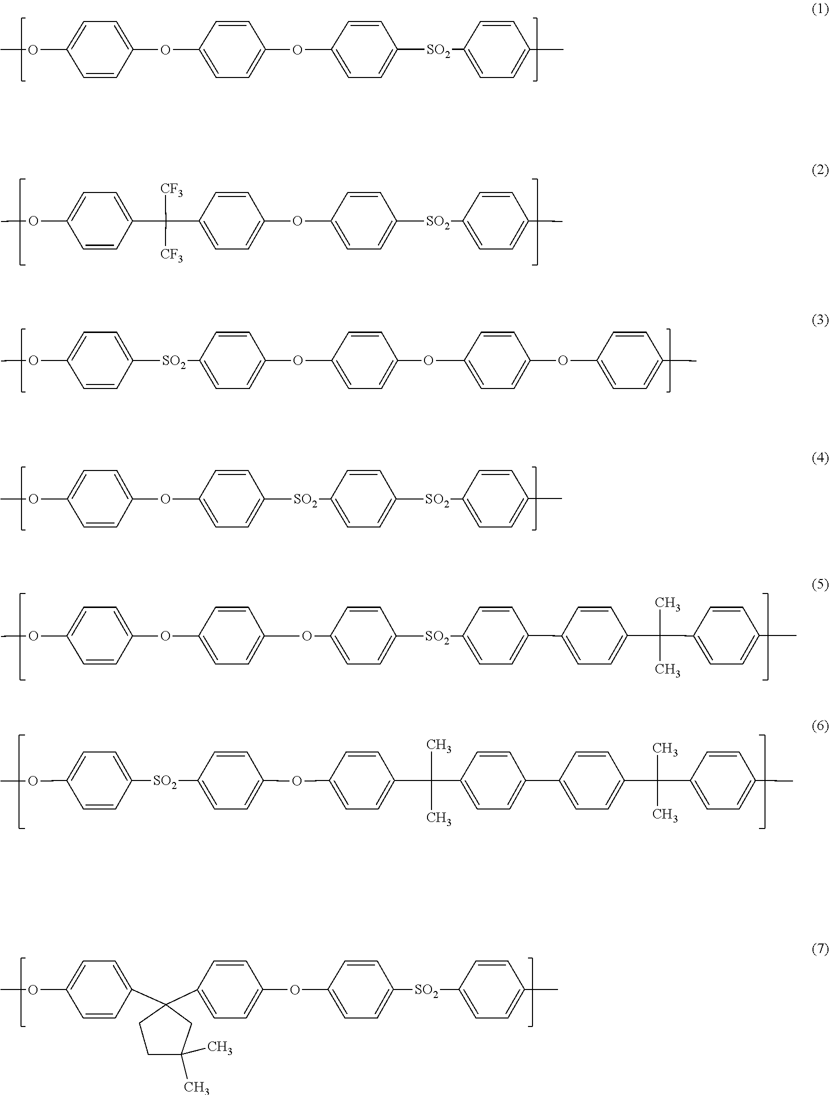

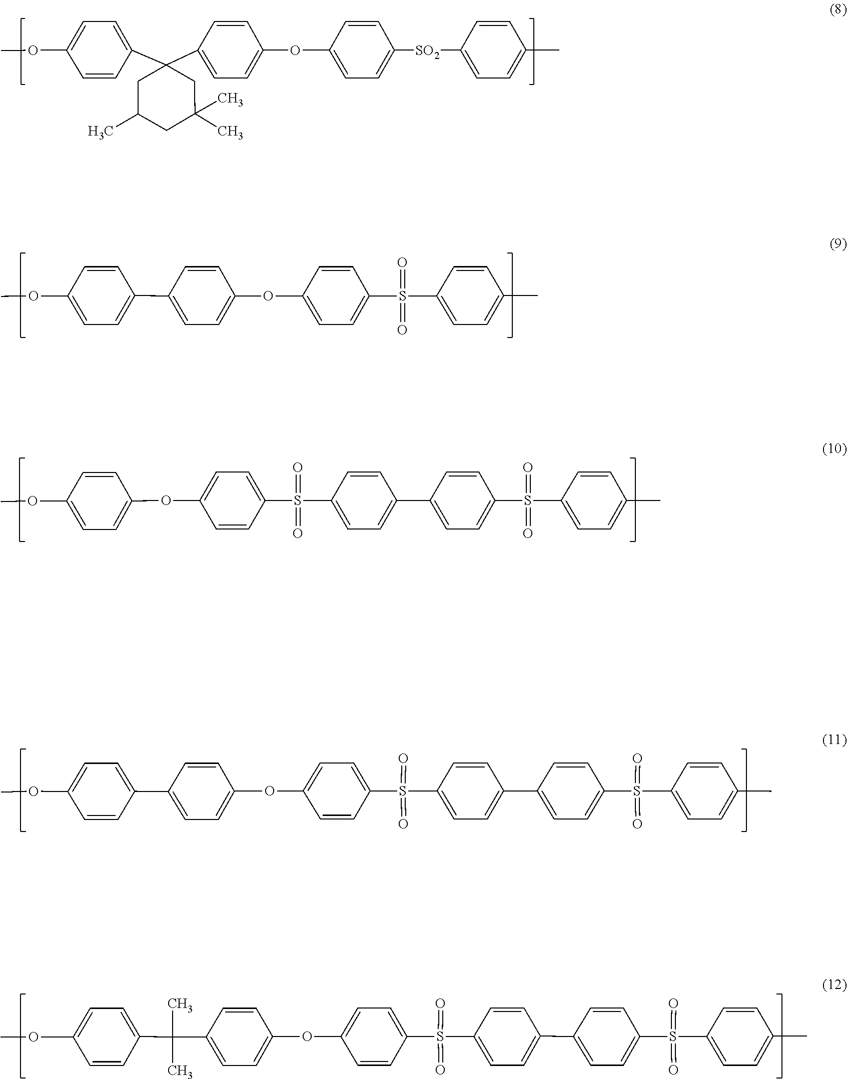

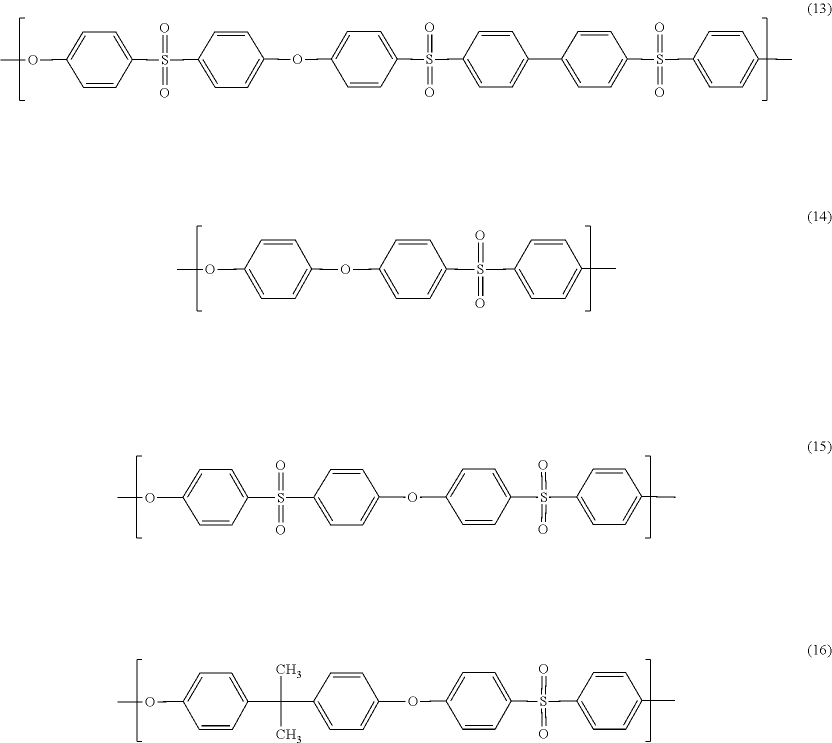

In addition to the units (1) to (16) preference is also given to those units in which one or more 1,4-dihydroxyphenyl units are replaced by resorcinol or dihydroxynaphthalene units.

Particularly preferred units of the general formula (III) are units (9), (15) and (16). It is also particularly preferred when the polyarylene ether blocks are formed essentially from one kind of units of the general formula (III), especially from one unit selected from (9), (15) and (16).

The degree of polymerization (calculated on the basis of repeating units composed of one monomer (M1) and one monomer (M2), of the thus obtained polymer may be in the range of 40 to 120, in particular 50 to 80 or 55 to 75.

### 2. Preparation of a NF Composite Membrane Carrying a Supramolecular Separation Layer (F)

For preparing a composite membrane suitable for NF applications, the substrate (S) is further modified by depositing a self-assembled supramolecular active layer (F) onto its surface. For this purpose commercially available porous polyethersulfone-based membrane substrate layer (S) of different geometry (flat sheets, hollow fibres) may be applied.

Care has to be taken that substrate membranes of proper pore size are chosen, the pore size should be such that the supramolecular fibrils of the self-assembling material are retained on the surface of the substrate and do not pass through.

The preparation of a composite membrane of the invention comprises the following steps
a) providing a porous substrate membrane layer (S) of suitable pore size,
b) providing a solution of at least one self-assembling perylene diimide in an aqueous solvent containing an organic co-solvent, as for example a dipolar aprotic solvent, like THF, in a proportion suitable for reducing the molecular weight of the supramolecular perylene diimide structures, as for example in a proportion of 0.5 to 30 or 1 to 15 Vol.-%;
c) passing said solution of step b) through the porous substrate layer (S) of step a), thereby depositing said at least one self-assembled perylene diimide from said solution onto said substrate layer (S) to form a porous self-assembled supramolecular membrane (F), optionally followed by washing the deposited membrane with an aqueous liquid, preferably water, and preferably maintaining said membrane in said aqueous liquid; and optionally repeating steps b) and c) with the same solution or a solution with different, preferably higher, proportion of an organic, preferably the same, co-solvent; and
d) optionally the deposited porous self-assembled supramolecular membrane (F) is subjected to a post-deposition treatment by applying an aqueous-alkanolic solvent, in particular a water/ethanol mixture having an ethanol content in a proportion of 25 to 75 Vol.-% to said deposited membrane.

More particularly the perylene diimide, like PP2b is dissolved at a suitable temperature, like ambient temperature, in the organic solvent, like in particular THF. Then a mixture of water and THF is added to the solution at room temperature in a proportion to adjust the intended final concentration of the organic solvent.

This solution is then pumped through said substrate layer by adjusting a suitable water flux, depending on the pore size and size of the membrane material (S), for example in the range of 0.05 to 1 mL/min/0.7 cm²′ or 0.5 to 10 L/m²/h through said membrane. For example the substrate layer may be a flat sheet membrane mounted in conventional filter housing. Two or more identical or different layers may be deposited on a flat sheet in the same manner by repeating the deposition procedure.

To deposit the perylene diimide, like PP2b, at the inner side of hollow bores, for example of a conventional INGE mulitbore® systrem, the permeate flow thereof is reduced to zero, and the PP2b solution in the desired water/THF mixture is flushed through the bores (feed flow=retentate flow; permeate flow=0), until the liquid volume inside the bores is exchanged at least twice. Then, the flows are switched to deposition (feed flow=permeate flow; retentate flow=0). The PP2b solution is thus deposited onto the inner side of the bores. The pump speed may be for example in the range of 0.1 to 5 mL/min per 10 cm per multibore strand. Two or more identical or different layers may be deposited in the same manner deposited,

In order to obtain improved retention of multivalent ions and dissolved organic matter, an already deposited PP2b structure may be partially dissolved in order to reduce the sizes of the self-assembled structures of PP2b after deposition.

For this purpose a densification treatment may be performed with an alkanol/water mixture, as for example an ethanol/water mixture of appropriate mixing ratio, as for example 1:2 to 2:1, in particular with an 1:1 EtOH:H₂O solution. The membrane structure is flushed with said solution until the intended degree of densification is obtained Subsequently the obtained densified membrane is flushed with water.

### Experimental Part

### Materials:

PP2b ((5,5′-bis(1-ethylyl-7-polyethylene glycol-N,N′-bis(ethylpropyl)-perylene-3,4,9,10-tetracarboxylic diimde)-2,2′-bipyridine) as used in the following examples is represented by the above-mentioned formula II and was synthesized according to the teaching of WO2012/025928, in particular Example 3. The average chain length of the polyethylene glycol side chains was adjusted to 17.

PES membrane of the type NADIR UP150, specified with a nominal molecular-weight-cut-off at 150 kDa, was cut to circular flat sheets with an effective area of 0.7 cm².

“Inge Multibore® membranes 0.9” with an average diameter of 0.9 mm per channel and an outer membrane diameter of 4.0 mm.

“Inge Multibore® membranes 1.5” with an average diameter of 1.5 mm per channel and an outer membrane diameter of 6.0 mm.

### Methods:

### a) Determination of Permeance

All experiments were performed at ambient conditions. The membranes were flushed by de-ionized water at a controlled flux of 0.1 mL/min. By measuring the overpressure before the membrane, the gravimetrically determined mass of eluted water over at least 10 minutes, and knowing the density of water and the area of the membrane, the permeance in units of L/m²/h/bar is calculated. The density of water is assumed to be 0.997 g/mL for this purpose.

### b) Determination of Ion Retention:

In general, analytical methods of established in water analytics may be applied for the measurement of ions like Pb²⁺ and (PO₄)³⁻. See for example Rolf Pohling, Chemische Reaktionen in der Wasseranalyse, Springer Verlag Berlin Heidelberg 2015.

### Method for Determination of Pb²⁺ Ion Retention:

A solution of 50 ppm Pb(NO₃)₂ was prepared in de-ionized water. 10 ml of this Pb(NO₃)₂ solution were added into the permeation cell (diameter 45 mm), which is then pressurized (2 bar) until 3 mL were eluted, then 5 mL (still 2 bar) Permeat are collected for analysis. Identical experiments were performed with a bare PES support without PP2b, and served as negative control. The Pb²⁺ content in the eluate was quantified by Inductively-coupled-plasma mass spectrometry (ICP-MS); in order to minimize contamination, no acid digestion was performed before ICP-MS analysis.

Other analytical methods for determining the Pb²⁺ content in the eluate are also known to the skilled reader and may be applied as well: as for example atomic absorption spectrometry (AAS), atomic emission spectrometry (AES), photometry based on formation of a colored dithiozon complex; or voltammetry.

Method for Determination of Phosphate (PO₄)³⁻ Retention:

For these experiments, membranes of larger dimension (10 cm² on NADIR UP150) were prepared. A solution of 200 ppm of Mg₃(PO₄)₂ was prepared in de-ionized water. 150 ml of this Mg₃(PO₄)₂ solution was added into the permeation cell (45 mm diameter) under continuous stirring. The permeation cell was pressurized at 2 bar for about 10 minutes and permeate collected. The conductivity of the initial feed and permeate were measured with a conductivity meter. The ratio between the conductivity values was taken as ratio of Mg₃(PO₄)₂ concentration.

Other analytical methods for determining the (PO₄)³⁻ content in the feed and permeate are also known to the skilled reader and may be applied as well: Gravimetric, Volumetric and Colorimetric methods. A colorimetric method are based on the formation of an coloured antimon-phosphormolybdato-complex is defined by EN ISO 6878.

### EXAMPLE 1

### Preparation of a PP2b Nanofiltration Membrane

0.1 mg of PP2b was dissolved in 30 μL of THF. Then 1 mL of a mixture of water and 3% m/m THF was added at room temperature. The solution was injected into the 1 mL-volume sample loop of a multivalve system, and was then flushed by water (water flux of 0.1 mL/min) into a permeation cell carrying in a metal membrane housing a PES supporting membrane (PES 0.7 cm² flat sheet; NADIR type UP150 membrane, with nominal 150 kDa cut-off). PP2b was deposited on said support membrane by a water flux of 0.1 mL/min through said membrane.

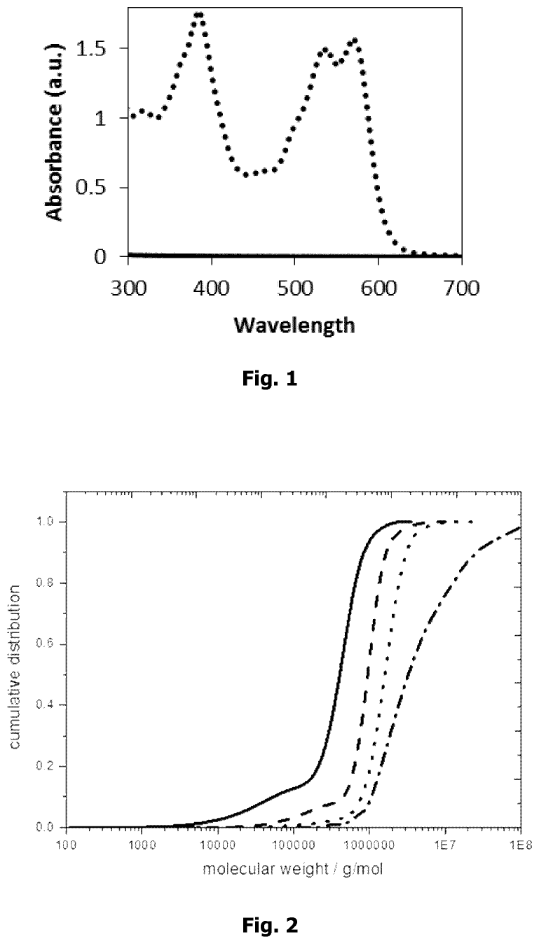

The UV-Vis spectrum (FIG. 1) of the liquid medium before (black, dotted line) and after the PES membrane (black line) clearly illustrate that PP2b was quantitatively deposited.

### EXAMPLE 2

### Control (Reduction) of the PP2b Pore Size by Increasing the Organic Solvent Content Before/During Deposition

In order to obtain retention of multivalent ions and dissolved organic matter, deposition was performed at an increased organic solvent content of the PP2b solution applied for deposition. Thereby, the self-assembled (non-covalent, supramolecular) structures of PP2b as formed before and during deposition are reduced in size.

As opposed to the method described in the prior art (WO2012/025928A1 and Krieg et al, Nature Nanotech 6, 2011, 141), which is restricted to THF contents around 0.75% (v/v) in water, according to the present invention significantly increased THF contents were applied for preparing a PP2b solution in a water/THF solvent system for performing said deposition.

The experiment was performed as follows:

Specifically, as described in Example 1 on a NADIR type UP150 PES membrane a first PP2b layer was deposited from a water/THF mixture at 3% (v/v) THF, followed by a second PP2b layer at 6% (v/v) THF. Each mixture contained PP2b in a concentration of 0.1 mg/mL.

Such smaller supramolecular structures formed by this method are only applicable on supporting membranes of suitably small pore size, like the NADIR type UP150 PES membranes, but not on membranes with 450 nm pore size, on which they would not deposit but just pass through.

In order to demonstrate that this approach really reduces self-assembled PP2b structures, an Analytical Ultracentrifugation method was used to quantify the molar mass of the supramolecular structures at specific THF contents in the water/THF mixture (AUC, Beckman model XLI, evaluation by Sedfit 14.0, described in Cölfen, H. and A. Völkel (2004). “Analytical ultracentrifugation in colloid chemistry.” Progress in Colloid+Polymer Science 127: 31, and Schuck, P. (1998). “Sedimentation analysis of noninteracting and self-associating solutes using numerical solutions to the Lamm equation.” Biophysical Journal 75(3): 1503-1512.).

As illustrated by the graphical illustration of the analysis (FIG. 2) said approach effectively reduces the fibrille size already before deposition. Thus separation membranes with smaller pore sizes are the result. Quantitatively, we find:

TABLE 1

| THF content *) | PP2b fibrils below 10\hat{ }6 g/mol | |
|---|---|---|
| 1% | 8% | dash-dotted line |
| 3% | 19% | dotted line |
| 6% | 56% | dashed line |
| 10% | 94% | solid line |

*) before and during deposition

Thus, by increasing the THF content, it is possible to form separation membranes with increasingly smaller pore sizes and consequently reduced permeance.

TABLE 2
Permeance data of different membrane

| | | Per- |
|---|---|---|
| | | meance |
| | | L/m²/ |
| No. | Typ of composite membrane | h/bar |
| 1 | PES + (control, support membrane alone) | >300 |
| 2 | PES + PP2b THF 0.8% | >200 |
| 3 | PES + PP2b THF 0.8% + PP2b THF 0.8% + PP2b THF 0.8% | 57 |
| 4 | PES + PP2b THF 3.0% + PP2b THF 6.0% (see Example 2) | 29 |
| 5 | PES + PP2b THF 3.0% + PP2b THF 15.0% | 19 |
| 6 | PES + PP2b THF 3.0% + PP2b THF 15.0% + PP2b THF 30% | 9 |
| 7 | PES + PP2b THF 3.0% + PP2b THF 6.0% + | 5 |
| | EtOH:H₂O 1:1 densification (see Example 3, below) | |

Membranes No.2, 3, 5 and 6 were prepared in analogy to membrane 4, Example 2 by applying PP2b solutions of different THF content; the PP2b concentration of each solution was 0.1 mg/mL

### EXAMPLE 3

### Control (Reduction) of the PP2b Pore Size By Densification After Deposition

In order to obtain improved retention of multivalent ions and dissolved organic matter, an already deposited PP2b structure was partially dissolved in order to reduce the sizes of the self-assembled (non-covalent, supramolecular) structures of PP2b after deposition.

The experiment was performed as follows:

A single layer or double layer of PP2b (0.1 mg/mL) was deposited on NADIR type UP150 PES from a water/3% (v/v) THF mixture as above. Then, a sample loop of 2 mL was filled with 1:1 EtOH:H₂O solution, and was injected at 3 bar pressure and 0.075 mL/min. The obtained membrane was then flushed with at least 2 mL of water.

On NADIR type UP150 PES we find that the formation of smaller supramolecular structures (densification) significantly improves the retention of phosphate and heavy metal ions (see Table 3).

The formation of denser structures is confirmed by the observation that the flux decreases:
Flux before densification: 80 (L/m2/bar/hr)
Flux after densification: 18 (L/m2/bar/hr)

TABLE 3
Increased Ion Retention after Densification

| Membrane | Pb³⁺retention (%) | PO₄³⁻ retention (%) |
|---|---|---|
| PP2b with densification | 12 | 40 |
| PP2b without desification | 0 | 21 |

### EXAMPLE 4

### PP2b Deposition on INGE Multibore® Membrane

A commercial INGE Multibore® membrane (0.9″) was applied.

To deposit PP2b at the inner (active) side of the hollow bores, the permeate flow is reduced to zero, and the PP2b solution in water/THF mixture is flushed at 3 mL/min per multibore strand through the bores (feed flow=retentate flow; permeate flow=0), until the liquid volume inside the bores is exchanged at least twice. This ensures homogeneous concentration throughout the length of the module. Then, the flows are switched to deposition (feed flow=permeate flow; retentate flow=0). The PP2b solution is thus deposited by dead-end flow with 3 mL/min per multibore strand onto the inner side of the bores. In this procedure, the amount of PP2b is adjusted to 0.12 mg/cm² of the module for each layer. In the laboratory modules with a single multibore membrane strand of length 15 cm, corresponding to an active surface inside the bores of 41 cm², each layer consisted of 4.5 mg PP2b.

Two layers are deposited, the first one with 3% THF, the second one with 6% THF. Then, the densification by flushing with 5 mL of a 1:1 EtOH:H₂O solution is performed at 3 mL/Min. During this procedure, the pressure is observed to rise to a of 0.3 bar value (after deposition of the 3% THF layer), to a value of 1.9 bar (after deposition of the 6% THF layer), and to a value of 4.3bar (after densification). This final pressure corresponds to a permeation of 14/m²/bar/hr. The rising pressure (thus decreasing permeation) is direct evidence of the gradually reducing pore sizes.

The entire deposition is performed at room temperature.

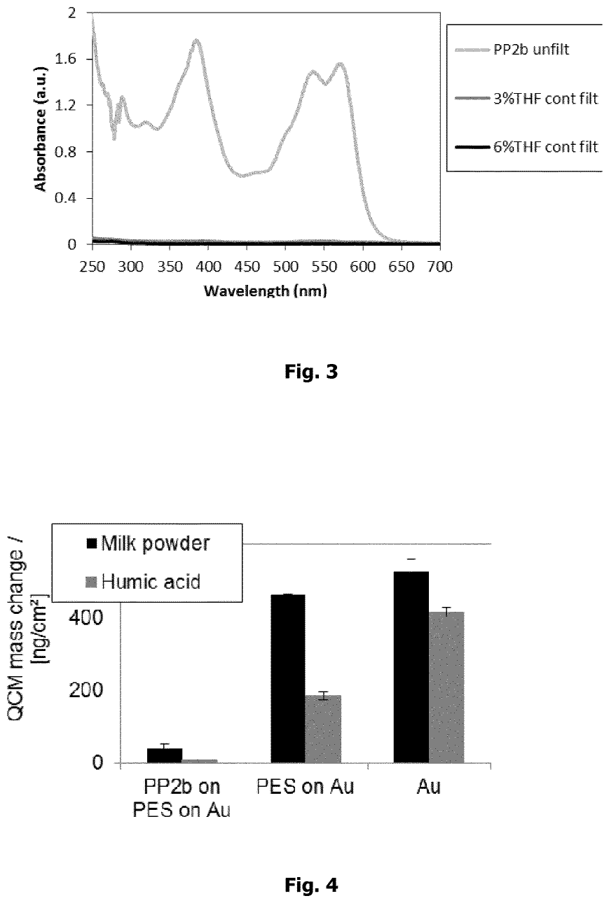

The successful deposition inside INGE Multibore® (surface area 41 cm²) was confirmed by UV-Vis spectroscopy of the water that eluted during the deposition process. This was done with a dead end-flow through the module. Samples were collected at 3 min and 5 min from a single output connecting the two dead-end outputs. The absence of the Vis-absorption confirms that no PP2b permeates the membrane i.e. is quantitatively deposited (FIG. 3).

Homogeneity of deposition was confirmed by photography of a sacrificed multibore hollow fiber, as taken in the region 10 cm distant from the injection site (picture not shown). The homogenous deep red color of deposited PP2b confirms a homogeneous deposition and the absence of white spots (naked PES) confirm that there was no negative interference, e.g. of air bubbles.

Comparing dead-end deposition of PP2b (as in this example) vs cross-flow deposition of PP2b, optical microscopy images inside the multibore module show that the PP2b only deposits under dead-end flow and does not adhere to the supporting membrane if it is only pumped in cross-flow for 1 h.

Once deposited, the mechanical stability of the deposited layer inside the module was investigated. After deposition by the procedure of this example, the cross-flow speed through the multibore inner bores was ramped up and down in a range 4 and 10 mL/min. After each change, the permeance in dead-end flow was determined, and was found to be stable.

### EXAMPLE 5

### Methylene Blue Retention By Different PP2b Membrane Types

### a) Membranes Applied:

Flat sheet membranes. (0.7 cm² and 10 cm²) prepared as described in Example 3 INGE Multibore® (41 cm²) prepared as described in Example 4

The flux only minimally increases inside the multibore module, and is clearly dominated by the PP2B structures, not by the original PES multibore (which has flux values far above 100, approx 300 L/m²/bar/h).

b) Measurement of Methylene blue Retention

Methylene blue (0.002 g/L in water) was filtered dead-end at pressure below 1bar through PP2b (deposited by the increased-THF-method, one PP2B layer at 3% THF, a second PP2B layer at 6% THF) to test the ability of PP2b to filter organics. UV-Vis spectroscopy showed nearly complete decrease of the methylene blue peaks at −290 nm and −660 nm. The results are summarized in Table 4.

TABLE 4
Methylene Blue retention by different PP2b membranes

| | PP2b mass per | Methylene | |
|---|---|---|---|
| | surface area | Blue retention | Flux |
| Membrane | (mg/cm²⁾ | (%) | (L/m²/bar/hr) |
| Prepared as in Ex. 2 | 0.24 | 71.50 | 24 |
| (3% THF, then 6% THF), | (0.12 | | |
| then densified as in Ex. 3, | from each | | |
| with 0.7 cm² | layer) | | |
| Prepared as in Ex. 2 | 0.24 | 77.17 | 33 |
| (3% THF, then 6% THF), | | | |
| then densified as in Ex.3, | | | |
| with larger area (10 cm²) | | | |
| Prepared as in Ex.5, | 0.24 | 14.69 − 75.38 | 51 |
| inside Inge Multibore | | | |
| (41 cm²) | | | |

### EXAMPLE 6

### PP2b Induced Reduction of Membrane Fouling

An anti-adsorption effect of PP2B was investigated. The measurement shows that PP2b very effectively reduces the adsorption of proteins (from dissolved milk powder) and of humic substance (from a humic soil extract).

### Method:

Quartz-crystal-microbalance is a standard assay for adsorption (Lu, Chao, and Alvin Warren Czanderna, eds. Applications of piezoelectric quartz crystal microbalances. Elsevier, 2012. ISBN 0-444-42277-3 (408 pages)). Quartz crystals were coated stepwise by Au, then by PES (Ultrason 6020P), then by PP2b (−0.4 g/L in CHCl₃, spin coated at 1500 rpm, 30 s, 20 μL). At each deposition step, quartz crystals were withdrawn and subjected to simulated fouling:
1. Flushing by water for 10 min.
2. Flushing/incubation in fouling simulants (Milk powder; humic acids) for 30 min: pH 7, Flow rate=250 μL/min., 23° C.
3. Flushing in water, recording the resonance frequency change vs. step 1.
4. Evaluation to adsorbed mass in ng/cm².

The results are shown in FIG. 4.

The results indicate a 93% reduction of adsorption, considered as very successful prevention of fouling.

### EXAMPLE 7

### PP2b Application to the Filtration of Heavy Metal Ions

The present results were obtained on PP2b deposited by the “densification” method on PES flat sheets 0.7 cm² area (see Example 3).

Solutions of ultrapure water with 50 ppm of different heavy metal ions were separately prepared from well-soluble salts of Ni³⁺, Cr³⁺, Zn²⁺, Pb³⁺, Ca²⁺. A volume of 10 mL of these solutions was injected into the sample loop, pumped in dead-end filtration through membranes that were freshly prepared for each of these solutions. The first 3 mL of eluate were discarded, and the next 5 mL were collected for analysis.

The heavy metal ion content in the eluate was quantified by Inductively-coupled-plasma mass spectrometry (ICP-MS) with internal standards. In order to minimize contamination, no acid digestion was performed before ICPMS analysis.

The results are summarized in Table 5.

TABLE 5
Heavy Metal Ion Retention

| | Ni, Cr, Zn | Pb | Ca | Flux |
|---|---|---|---|---|
| | Retention | Retention | Retention | (L/m²/ |
| Membrane | (%) | (%) | (%) | bar/hr) |
| Prepared as in Ex. 2 | 58-70 | 12 | 10 | 24 ± 8 |
| (3%THF, then 6% THF), | | | | |
| then densified as in Ex. 3 | | | | |

### EXAMPLE 8

### PP2b Application to the Filtration of Phosphates

The following membranes were prepared:
a) with a flat sheet area of 10 cm²:
   NADIR UP150 PES+PP2b (0.12 mg/cm² from 3% THF:H₂O)+PP2b (0.12 mg/cm² from 6% THF:H₂O)+50% EtOH:H₂O (densification treatment)
   NADIR UP150 PES+PP2b (0.12 mg/cm² from 3% THF:H₂O)+PP2b (0.12 mg/cm² from 6% THF:H₂O) (as in Example 2)
b) with INGE Multibore® (41 cm²) modules:
   Inge Multibore® module 2=2×PP2b (0.15 mg/cm² per layer, which corresponds to 4.5 mg PP2b at 15 cm length) with 3% and 6% THF (without EtOH densification treatment).
   Inge Multibore® module 3=2×PP2b (0.15 mg/cm² per layer, which corresponds to 4.5 mg PP2b at 15 cm length) with 3% and 6% THF, 5 ml 30% EtOH:H₂O (densification treatment). (as in Example 4)

### Method for Water Permeability Testing:

Distilled water was added into the permeation cell and pressurized at 1 bar for 30 minutes. Permeate readings were taken

### Method for Rejection Tests:

200 ppm of Mg₃(PO₄)₂ and MgSO₄ were prepared.

150 ml of Mg₃(PO₄)₂ was added into the permeation cell under continuous stirring. The permeation cell was pressurized for about 10 minutes and the permeate was collected. The conductivity of the initial feed and the permeate were measured with a conductivity meter. The permeation cell was rinsed with DI water and DI water was pressurized at 1 bar for cleaning of the membrane.

The steps were repeated for MgSO₄.

TABLE 6
10 cm² Membrane results:

| | | Mg₃(PO₄)₂ | MgSO₄ |
|---|---|---|---|
| | Water flux | retention | retention |
| Membrane | (L/m²/hr/bar) | (%) | (%) |
| PP2b + EtOH | 56.1 | 40.0 | 6.0 |
| PP2b | 380.5 ± 62.5 | 20.8 ± 0.2 | 2.6 ± 0.1 |

The results demonstrate that the densification procedure increases the membrane performance for phosphate retention.

TABLE 7
INGE Multibore module results

| | | Mg₃ | | | |
|---|---|---|---|---|---|
| | Water | (PO₄)₂ | Mg₃ | MgSO₄ | |
| INGE | Per- | Per- | (PO₄)₂ | Per- | MgSO₄ |
| Multi- | meability | meability | Reject- | meability | Reject- |
| bore | (L/m²/ | (L/m²/ | ion | (L/m²/ | ion |
| ID | hr/bar) | hr/bar) | (%) | hr/bar) | (%) |
| module 2 | 65 | 60 | 29.9 | 60 | 3.4 |
| module 3 | 44 | 32 | 35.9 | 33 | 4.0 |

The results obtained for INGE multibore are consistent with the flat sheet results and confirm that the deposition was effective despite the more complex procedure and morphology inside the multibore system, and again confirm that the densification increases the membrane performance.

### EXAMPLE 9 (Comparative)

### Investigating Applicability of PP2b Layers Obtained According to WO2012/025928 for the Filtration of Heavy Metals and Organic Dyes

### a) Heavy Metal Filtration

Using PP2b in H₂O (containing 0.9% THF), a layer was deposited on a support (PES) with a pore size of 0.45 μm as suggested in WO2012/025928. The absence of red color of the eluate, the observed pressure increase of up to 0.57 bar (at 0.2 mL/min), and finally the red Perylene layer on the support all indicate a successful deposition of PP2b (consistent with WO2012/025928).

On thus prepared membranes, one individually for each metal, 10 mL of aqueous solutions of three different heavy metals (Cr, Ni, Zn) at 50 ppm metal content were filtered. The content of heavy metal was determined by ICPMS in the eluate and in the original solution.

A difference of that less than 1 ppm (corresponding to less than 2% retention, i.e. practically zero retention of heavy metals) was observed.

This confirms that the process and material described in the prior art are not effective to filter heavy metals and thus differ from the teaching of the present invention significantly.

### b) Methylene Blue Filtration:

Using PP2b in H₂O (containing 0.9% THF), a layer was deposited on a support (PES) with a pore size of 0.45 μm as suggested in WO2012/025928. The absence of red color of the eluate, and the red Perylene layer on the support all indicate a successful deposition of PP2b (consistent with WO2012/025928).

Then, 5 mL of a solution of methylene blue at 5 mg/L are filtered. The first 2 mL are discarded. The next 2 mL elution is measured by UV VIS spectrometry, finding no reduction of dye absorption by the PP2b layer.

This confirms that the process and material described in the prior art are not effective to filter the dye and thus differ from the teaching of the present invention significantly.

The disclosure of herein cited documents is incorporated by reference.

1. A nanofiltration composite membrane, comprising:
a polymeric porous substrate layer (S) comprising a substrate layer forming polymer (P1), wherein the polymeric porous substrate layer (S) has a mean pore size of from 10 to 150 nm, and
a porous self-assembled supramolecular membrane layer (F) comprising, supramolecular fibrils of a self-assembled perylene diimide deposited on the polymeric porous substrate layer (S),
wherein the porous self-assembled supramolecular membrane layer (F) is obtained by passing through the polymeric porous substrate layer (S) a solution comprising supramolecular fibrils of the self-assembled perylene diimide in an aqueous solvent, which comprises THF as an organic cosolvent in a proportion of 1 Vol.-% or more, based on a total volume of the solution.

2. The nanofiltration composite membrane of claim 1,
wherein the aqueous solvent comprises the THF in a proportion of up to 30 Vol.-%, based on the total volume of the solution.

3. The nanofiltration composite membrane of claim 1,
wherein the aqueous solvent comprises the THF in a proportion of from 1 to 30 Vol.-%, based on the total volume of the solution.

4. The nanofiltration composite membrane of claim 1,
wherein the nanofiltration composite membrane is further characterized by at least one of following ion retention parameters:
i) Pb²⁺ retention of at least 5%; and
ii) PO₄³⁻ retention of at least 10%.

5. The nanofiltration composite membrane of by claim 1,
wherein the nanofiltration composite membrane has a flux of from 10 to 80 L/m²/bar/h, as determined under standardized conditions.

6. The nanofiltration composite membrane of claim 1,
wherein the porous self-assembled supramolecular membrane layer (F) has a mean pore size of from 1 to 10 nm.

7. The nanofiltration composite membrane of claim 1,
wherein the polymeric porous substrate layer (S) has a mean pore size of from 10 to 100 nm.

8. The nanofiltration composite membrane of claim 1,
wherein the self-assembled perylene diimide, comprises a perylene diimide of Formula I or a salt or metal complex thereof: 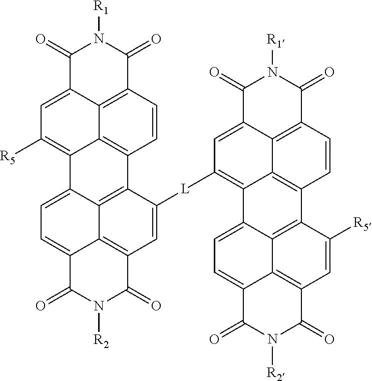
wherein
R₁ and R_{1′} are each independently [(CH₂)_{q}O]ᵣCH₃, [(CH₂)_{q}O]ᵣH [(CH₂)_{q}C(O)O]ᵣCH₃, [(CH₂)_{q}C(O)NH]ᵣCH₃₆, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si—A, or [C(O)CHR₃NH]ₚH wherein the aryl or heteroaryl groups are optionally substituted by 1-3 groups comprising halide, CN, CO₂H, OH, SH, NH₂, CO₂-(C₁-C₆ alkyl) or O—(C₁-C₆ alkyl); wherein A comprises three same or different substituents of Cl, Br, I, O(C₁-C₈)alkyl or (C₁-C₈)alkyl; and wherein R₃ in the [C(O)CHR₃NH]ₚH is an alkyl, haloalkyl, hydroxyalkyl, hydroxyl, aryl, phenyl, phenylalkyl, aminoalkyl and independently the same or different when p is larger than 1;
R₂ and R₂′ are each independently [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si—A, or [C(O)CHR₄NH]ₛH wherein the aryl or heteroaryl groups are optionally substituted by 1-3 groups comprising halide, CN, CO₂H, OH, SH, NH₂, CO₂-(C₁-C₆ alkyl) or O-(C₁-C₆ alkyl); wherein A comprises three same or different substituents of Cl, Br, I, O-(C₁-C₈)alkyl or (C₁-C₈)alkyl; and wherein R₄ in the [C(O)CHR₄NH]ₛH is an alkyl, haloalkyl, hydroxyalkyl, hydroxyl, aryl, phenyl, phenylalkyl, aminoalkyl and independently the same or different when s is larger than 1;
R₅ and R_{5′} are each independently H, —ORₓ where Rₓ is C₁-C₆ alkyl, [(CH₂)ₙO]ₒCH₃ or [(CH₂)ₙO]ₒH; [(CH₂)ₙC(O)O]ₒCH₃, [(CH₂)ₙC(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)ₙO]ₒCH₃, [(alkylene)ₙC(O)O]ₒCH₃, [(alkylene)ₙC(O)NH]ₒCH₃, [(alkylene)ₙCH₂═CH₂]ₒCH₃, [(alkylene)ₙCH≡CH]ₒCH₃, [(alkylene)ₙNH]ₒCH₃, aryl, heteroaryl, CH≡C-R₇, CH═R₈R₉, NR₁₀R₁₁, chiral group, amino acid, peptide or a saturated carbocyclic or heterocyclic ring wherein the saturated heterocyclic ring or heteroaryl contains comprises at least one nitrogen atom and R₅ or R_{5′} are connected via the at least one nitrogen atom and wherein the saturated carbocyclic ring, heterocyclic ring, aryl and heteroaryl groups are optionally substituted by 1-3 groups comprising halide, aryl, heteroaryl, CN, CO₂H, OH, SH, NH₂, CO₂-(C₁-C₆ alkyl) or O-(C₁-C₆ alkyl);
R₇ is H, halo, (C₁-C₃₂)alkyl, aryl, NH₂, alkyl-amino, COOH, C(O)H, alkyl-COOH heteroaryl, Si(H)₃ or Si[(C₁-C₈)alkyl]₃ wherein the aryl or heteroaryl groups are optionally substituted by 1-3 groups comprising halide, aryl, heteroaryl, CN, CO₂H, OH, SH, NH₂, CO₂-(C₁-C₆ alkyl) or O-(C₁-C₆ alkyl);
R₈, R₉, R₁₀ and R₁₁ are each independently H, (C₁-C₃₂)alkyl, aryl, NH₂, alkyl-amino, COOH, C(O)H, alkyl-COOH or heteroaryl wherein [[said]] the aryl or heteroaryl groups are optionally substituted by 1-3 groups comprising halide, CN, CO₂H, OH, SH, NH₂, CO₂-(C₁-C₆ alkyl) or O-(C₁-C₆ alkyl);
L is a linker;
n is an integer from 1 to 5;
o is an integer from 1 to 100;
p is an integer from 1 to 100;
q is an integer from 1 to 5;
r is an integer from 1 to 100; and
s is an integer from 1 to 100;
wherein if R₅ and/or R_{5′} are chiral; the nanofiltration composite membrane forms a chiral membrane.

9. The nanofiltration composite membrane of claim 6, wherein
L is selected from linkers of formulae (a) to (f) 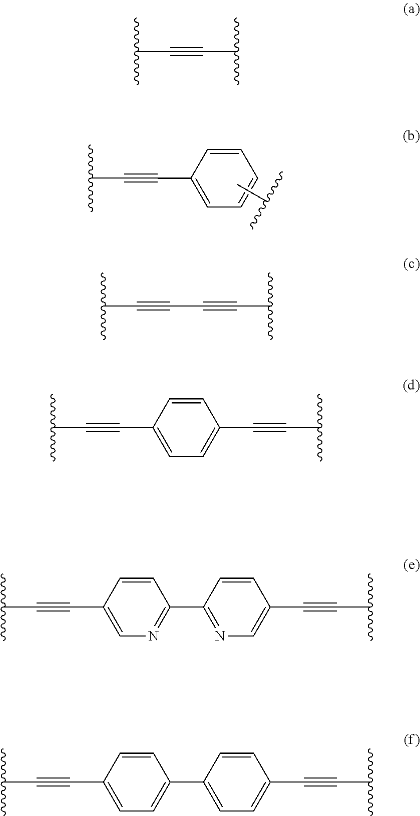
R₁ and R_{1′} are each independently (C₁-C₃₂)alkyl,
R₂ and R_{2′} are each independently (C₁-C₃₂)alkyl or (C₃-C₁₀)alkyl,
R₅ and R_{5′} are each independently [(CH₂)ₙO]ₒCH₃ or [(CH₂)ₙO]ₒH;
n is an integer from 1 to 5; and
o is an integer from 5 to 50.

10. The nanofiltration composite membrane of claim 1,
wherein the perylene diimide is a compound of Formula II: 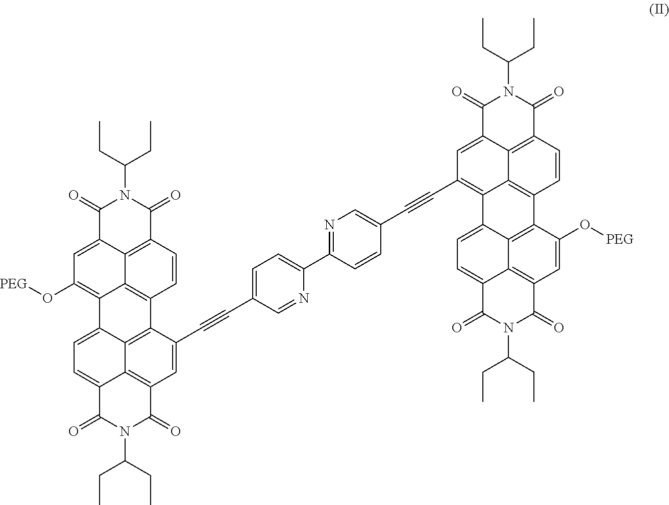
wherein PEG is a polyethylene glycol residue comprising from 10 to 25 consecutive ethylene glycol units (PEG10 to PEG25), or a mixture of at least two of the compounds.

11. The nanofiltration composite membrane of claim 1,
wherein the polymeric porous substrate layer (S) is a polyarylene ether-based layer.

12. The nanofiltration composite membrane of
claim 1, wherein the porous self-assembled supramolecular membrane layer (F) deposited on top of the polymeric porous substrate layer (S) has a layer thickness of at least 0.1 g/m² (mass of (F) per area of (S)).

13. The nanofiltration composite membrane of claim 1, in the form of a flat sheet,
wherein the polymeric porous substrate layer (S) has a layer thickness of from 50 to 250 μm.

14. The nanofiltration composite membrane of claim 1, in a tubular form,
wherein the polymeric porous substrate layer (S) has a layer thickness of from 50 to 2000 μm, and/or
wherein the porous self-assembled supramolecular membrane layer (F) is deposited on an inner surface of the polymeric porous substrate layer (S).

15. A method of preparing the nanofiltration composite membrane of claim 1, the method comprising:
a) providing at least one polymeric porous substrate layer (S),
b) providing a solution comprising supramolecular fibrils of at least one self-assembled perylene diimide in an aqueous solvent comprising an organic co-solvent in a proportion suitable for reducing a molecular weight of supramolecular perylene diimide structures; wherein in b) a solution comprising supramolecular fibrils of at least one self-assembled perylene diimide in an aqueous solvent is applied, wherein the aqueous solvent comprises THF as the organic co-solvent in a proportion of 1 Vol.-% or more, based on the total volume of the solution.
c) passing the solution of b) through the polymeric porous substrate layer of a), thereby depositing the supramolecular fibrils of at least one self-assembled perylene diimide from the solution onto the polymeric porous substrate layer (S) to form at least one porous self-assembled supramolecular membrane (F), optionally followed by washing at least one deposited porous self-assembled supramolecular membrane with an aqueous liquid; and
e) optionally repeating b) and c) with the same solution or a solution with different proportion of the organic co-solvent.

16. The method of claim 15,
wherein the aqueous solvent comprises the THF in a proportion of from 1 to 30 Vol.-%, based on the total volume of the solution.

17. The method of claim 15, further comprising:
d) performing a post-deposition treatment by applying the at least one deposited porous self-assembled supramolecular membrane (F) with an aqueous-alkanolic solvent.

18. A method of separation, filtration and/or purification of at least one metal cation and/or at least one inorganic anions anion, the method comprising:
passing an aqueous medium comprising a metal cation and/or an inorganic anion through the nanofiltration composite membrane of claim 1, thereby obtaining an aqueous filtrate depleted from at least one of the metal cation and the inorganic anion and a retentate enriched with at least one of the metal cation and the inorganic anion.

19. A method of separation or filtration of at least one water soluble organic molecule, the method comprising:
passing an aqueous medium comprising a water soluble organic molecule through the nanofiltration composite membrane of claim 1, thereby obtaining an aqueous filtrate depleted from at least one dye and a retentate enriched with the at least one dye.

20. A filter cartridge, comprising: the nanofiltration composite membrane of of claim 1, in a tubular form,
wherein the porous self-assembled supramolecular membrane layer (F) is deposited on an inner surface of the polymeric porous substrate layer (S).

21. A filtration device, comprising the filter cartridge of claim 20.

22. The method of claim 15,
wherein the nanofiltration composite membrane as applied therein has a permeance of from 1 to 200 L/m²/h/bar.

23. The nanofilteration composite membrane of claim 1, in the form of a flat sheet.

24. The nanofiltration composite membrane of claim 1, in the form of a multibore hollow fibre.

25. A filter cartridge, comprising the nanofiltration composite membrane of claim 1, in the form of a flat sheet.
